(19) United States
(12) Patent Application Publication
(10) Pub. No.: US 2026/0054710 A1
(43) Pub. Date: Feb. 26, 2026

(54) METHODS AND APPARATUS TO ESTIMATE BRAKE PAD WEAR

(71) Applicant: Ford Global Technologies, LLC, Dearborn, MI (US)

(72) Inventors: Anuj Pal, Saint Paul, MN (US); Ritik Singh, Mooresville, NC (US); Satheesh Kumar Chandran, Livonia, MI (US); Vicky Svidenko, Newcastle, WA (US)

(21) Appl. No.: 18/810,197

(22) Filed: Aug. 20, 2024

(51) Int. Cl. B60T 17/22; F16D 66/00; F16D 66/02

(52) U.S. Cl. CPC B60T 17/22; F16D 66/026; F16D 2066/001; F16D 2066/003; F16D 2066/005; F16D 2066/006

(57) ABSTRACT

Methods and apparatus to estimate brake pad wear are disclosed. An example apparatus includes at least one processor circuit to obtain temperature data and power data associated with a brake pad of a vehicle, execute a neural network based on the temperature data and the power data, the neural network trained based on a loss value corresponding to a difference between (a) a first rate of change of an output of the neural network when the neural network is executed based on training data, the first rate of change evaluated at a first temperature and a first power, and (b) a second rate of change proportional to a ratio between the first temperature and the first power, determine, based on a result of the execution of the neural network, a brake wear metric corresponding to the brake pad, and cause presentation of the brake pad metric via a user interface.

### FIELD OF THE DISCLOSURE

This disclosure relates generally to vehicles and, more particularly, to methods and apparatus to estimate brake pad wear.

### BACKGROUND

Braking operations cause brake pads to wear over time, which can affect braking capabilities of a vehicle. As a result, drivers schedule vehicle maintenance to replace the brake pads and, in turn, reduce a likelihood of non-ideal braking situations.

### SUMMARY

An example apparatus includes at least one processor circuit to be programmed by machine-readable instructions to obtain temperature data and power data associated with a brake pad of a vehicle, execute a neural network based on the temperature data and the power data, the neural network trained based on a loss value corresponding to a difference between (a) a first rate of change of an output of the neural network when the neural network is executed based on training data, the first rate of change evaluated at a first temperature and a first power, and (b) a second rate of change proportional to a ratio between the first temperature and the first power, determine, based on a result of the execution of the neural network, a brake wear metric corresponding to the brake pad, and cause presentation of the brake pad metric via a user interface.

At least one example non-transitory machine-readable medium includes machine-readable instructions to cause at least one processor circuit to at least obtain temperature data and power data associated with a brake pad of a vehicle, execute a neural network based on the temperature data and the power data, the neural network trained based on a loss value corresponding to a difference between (a) a first rate of change of an output of the neural network when the neural network is executed based on training data, the first rate of change evaluated at a first temperature and a first power, and (b) a second rate of change proportional to a ratio between the first temperature and the first power, determine, based on a result of the execution of the neural network, a brake wear metric corresponding to the brake pad, and cause presentation of the brake pad metric via a user interface.

An example method includes obtaining temperature data and power data associated with a brake pad of a vehicle, executing a neural network based on the temperature data and the power data, the neural network trained based on a loss value corresponding to a difference between (a) a first rate of change of an output of the neural network when the neural network is executed based on training data, the first rate of change evaluated at a first temperature and a first power, and (b) a second rate of change proportional to a ratio between the first temperature and the first power, determining, based on a result of the execution of the neural network, a brake wear metric corresponding to the brake pad, and causing presentation of the brake pad metric via a user interface.

### BRIEF DESCRIPTION OF THE DRAWINGS

FIG. 1 is a block diagram of an example environment in which example vehicle analysis circuitry and example model analysis circuitry may be implemented in accordance with teachings of this disclosure.

FIG. 2 illustrates an example brake of the vehicle of FIG. 1.

FIG. 3 is a block diagram of an example implementation of the vehicle analysis circuitry of FIG. 1.

FIG. 4 illustrates an example data matrix that may be generated by the vehicle analysis circuitry of FIG. 3.

FIG. 5 is a block diagram of an example implementation of the model analysis circuitry of FIG. 1.

FIG. 6 is a process flow diagram representative of an example model training architecture that may be implemented by the model analysis circuitry of FIG. 5 to generate and/or train one or more brake wear prediction models.

FIG. 7 is a process flow diagram representative of an example information exchange procedure that may be implemented by the example vehicle analysis circuitry of FIGS. 1 and/or 3 and the example model analysis circuitry of FIGS. 1 and/or 5.

FIG. 8 is a process flow diagram representative of an example brake wear prediction procedure that may be implemented by the vehicle analysis circuitry of FIGS. 1 and/or 3 and/or the model analysis circuitry of FIGS. 1 and/or 5.

FIG. 9 is a flowchart representative of example machine readable instructions and/or example operations that may be executed, instantiated, and/or performed by example programmable circuitry to implement the vehicle analysis circuitry of FIG. 3.

FIG. 10 is a flowchart representative of example machine readable instructions and/or example operations that may be executed, instantiated, and/or performed by example programmable circuitry to implement the model analysis circuitry of FIG. 5 to estimate brake pad wear.

FIG. 11 is a flowchart representative of example machine readable instructions and/or example operations that may be executed, instantiated, and/or performed by example programmable circuitry to implement the model analysis circuitry of FIG. 5 to generate and/or train one or more brake wear prediction models.

FIG. 12 is a block diagram of an example processing platform including programmable circuitry structured to execute, instantiate, and/or perform the example machine readable instructions and/or perform the example operations of FIG. 9 to implement the vehicle analysis circuitry of FIG. 3.

FIG. 13 is a block diagram of an example processing platform including programmable circuitry structured to execute, instantiate, and/or perform the example machine readable instructions and/or perform the example operations of FIGS. 10 and/or 11 to implement the model analysis circuitry of FIG. 5.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Vehicle brakes often include brake pads disposed on a caliper (e.g., a caliper assembly) of the brake. In some examples, the brake pads are composed of a rigid backplate and a friction pad coupled thereto. In some examples, when the brakes are engaged, the caliper is actuated towards the rotor, causing the brake pad to contact the rotor. The friction between the brake pad and the rotor converts kinetic energy of the rotating rotor into thermal energy, thereby slowing the rotation of the vehicle.

Over the service life of a brake pad, the friction pad is gradually worn due to the contact with the rotor. The brake pads may necessitate replacement when a thickness of the brake pads is less than a threshold (e.g., less than 2 millimeters (mm)). Because the amount of brake pad wear varies based on the usage of the vehicle (e.g., how frequently the vehicle slows, how forcefully the brakes are applied during a braking event, etc.) and/or a load on the vehicle (e.g., heavier vehicle loads causes greater brake pad wear, etc.), it can be difficult to estimate the wear of brake pads without visual inspection. Further, while designated sensor(s) (e.g., brake wear sensor(s)) may be implemented on the vehicle to detect brake pad wear, the addition of such sensor(s) can increase complexity and/or weight associated with the vehicle.

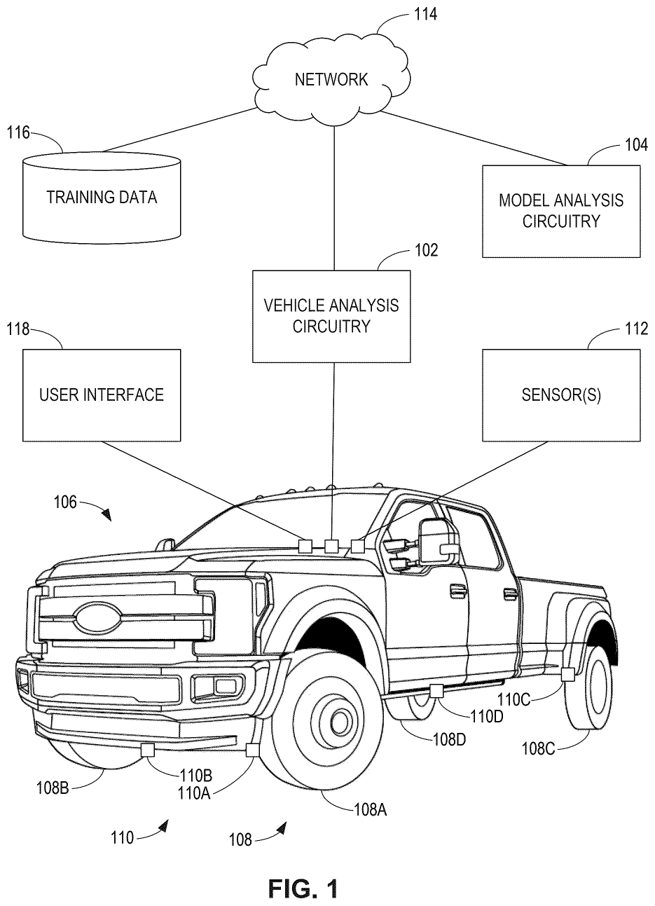

FIG. 1 is a block diagram of an example environment 100 in which example vehicle analysis circuitry 102 and example model analysis circuitry 104 may be implemented in accordance with teachings of this disclosure. In the illustrated example of FIG. 1, an example vehicle 106 implements the vehicle analysis circuitry 102. The vehicle 106 is a motorized wheel-driven vehicle including a first wheel (e.g., a front left wheel) 108A, a second wheel (e.g., a front right wheel) 108B, a third wheel (e.g., a rear left wheel) 108C, and a fourth wheel (e.g., a rear right wheel) 108D (collectively referred to herein as wheels 108), where the first and second wheels 108A, 108B correspond to front wheels and the third and fourth wheels 108C, 108D correspond to rear wheels of the vehicle 106. In the example of FIG. 1, the vehicle 106 is a pick-up truck. In other examples, the vehicle 106 can be any type of vehicle with brakes (e.g., a sedan, a coupe, a van, a pick-up truck, a sports utility vehicle, an all-terrain vehicle (ATV), farming equipment, etc.). In some examples, the vehicle 106 includes an internal combustion engine (e.g., a non-electrified vehicle, a partially electrified vehicle, etc.). In other examples, the vehicle 106 can be implemented as a fully electric vehicle.

In the illustrated example of FIG. 1, a first example brake (e.g., a first vehicle brake) 110A is associated with the first wheel 108A, a second example brake (e.g., a second vehicle brake) 110B is associated with the second wheel 108B, a third example brake (e.g., a third vehicle brake) 110C is associated with the third wheel 108C, and a fourth example brake (e.g., a fourth vehicle brake) 110D is associated with the fourth wheel 108D. In this example, the first brake 110A, the second brake 110B, the third brake 110C, and the fourth brake 110D (collectively referred to herein as brakes 110) are disc brakes. In some examples, one or more of the brakes 110 may be a different type of brake (e.g., an electro-mechanical brake (EMB), a drum brake, etc.).

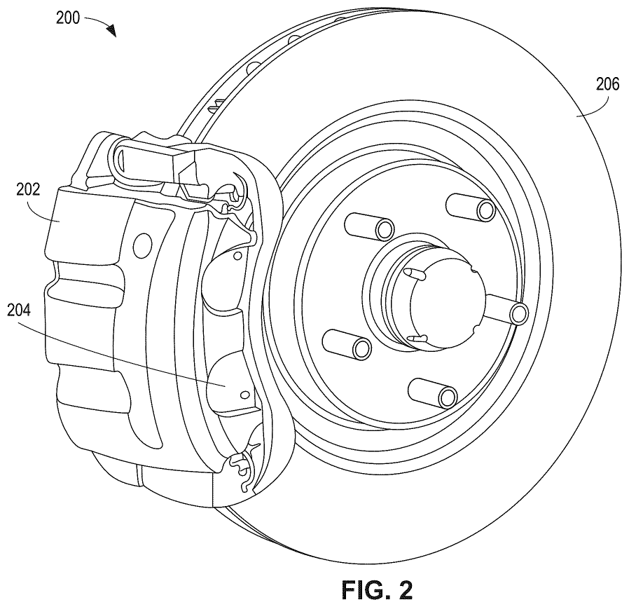

Turning to FIG. 2, an example disc brake assembly 200 that may be used for one(s) of the brakes 110 of FIG. 1 is shown. In the illustrated example of FIG. 2, the disc brake assembly 200 includes an example caliper assembly 202 and one or more example brake pads 204 movable relative to (e.g., toward and/or away from) an example rotor 206 associated with one of the wheels 108 of FIG. 1. In some examples, the caliper assembly 202 can be actuated (e.g., electrically and/or mechanically) to move the brake pads 204 toward the rotor 206 to apply a clamping pressure onto the rotor 206. In this example, the rotor 206 is a disc that is coupled (e.g., rigidly coupled) to and rotatable with a respective one of the wheels 108 of FIG. 1. The rotor 206 can have any suitable shape (e.g., circular, etc.) and/or any suitable features (e.g., slots, holes, etc.).

During operation of the disc brake assembly 200, the caliper assembly 202, via the brake pads 204, applies a force (e.g., a frictional force, a clamping force) to the rotor 206 to slow rotation of the rotor 206 and the respective wheel 108 to reduce a travel speed of the vehicle 106. The brake pads 204 are designed to abrade (e.g., wear) on contact with the rotor 206 and, as a result, reduce (e.g., restrict, prevent) deformation and/or warping of the rotor 206 and/or the caliper assembly 202. Over the course of the service life of the vehicle 106, the brake pads 204 may necessitate replacement to maintain braking efficiency of the disc brake assembly 200.

Returning to FIG. 1, the vehicle analysis circuitry 102 accesses and/or obtains example sensor data from one or more example sensors 112 of the vehicle 106. In some examples, the sensors 112 can include one or more example torque sensors, one or more example temperature sensors (e.g., ambient temperature sensor(s)), and/or one or more example speed sensors implemented on and/or operatively coupled to the vehicle 106. In some examples, the torque sensor(s) measure and/or detect torque (e.g., brake torque) applied to respective one(s) of the wheels 108 of the vehicle 106. For example, the torque corresponds to a force (e.g., in Newton-meters (N-m)) applied by one(s) of the brakes 110 on the respective wheel(s) 108 (e.g., on a rotor of the wheel(s) 108). In some examples, the temperature sensor(s) measure and/or detect an ambient temperature (e.g., in degrees Celsius (° C.)) of the vehicle 106 (e.g., corresponding to an environment surrounding the vehicle 106), and the speed sensor(s) measure a speed (e.g., a travel speed) of the vehicle 106 (e.g., in kilometers per hour (kph)). In some examples, the vehicle analysis circuitry 102 obtains the sensor data via a controller area network (CAN) bus of the vehicle 106. In some examples, the vehicle analysis circuitry 102 obtains the sensor data periodically (e.g., every second, every 10 seconds, every 20 seconds, etc.).

In some examples, the vehicle analysis circuitry 102 calculates, based on the sensor data, example power data and/or example temperature data associated with respective one(s) of the wheels 108. For example, when the brakes 110 are engaged (e.g., are in contact with a rotor of the respective one(s) of the wheels 108), the brakes 110 apply power to the respective wheel(s) 108. Further, heat may be generated as a result of friction between the brake pads of the brakes 110 and the rotating rotors, resulting in an increase in temperature at the respective wheel(s) 108. In some examples, the power data represents the power applied to respective one(s) of the wheel(s) (e.g., the front wheel(s) 108A, 108B and/or the rear wheel(s) 108C, 108D), and/or represents a total (e.g., combined) power applied to the wheels 108 by the respective brakes 110. In some examples, the temperature data represents temperature(s) at an interface between the brake pads of the brake(s) 110 and respective rotor(s) of the wheel(s) 108.

In the illustrated example of FIG. 1, the vehicle analysis circuitry 102 is communicatively coupled to the model analysis circuitry 104 (e.g., via an example network 114) to provide (e.g., send, transmit) the calculated power and/or temperature data to the model analysis circuitry 104 for use in estimating brake pad wear. In some examples, the vehicle analysis circuitry 102 generates an example data matrix (e.g., a histogram matrix) based on the power data and/or the temperature data, and provides the power data and the temperature data to the model analysis circuitry 104 by transmitting the data matrix via the network 114. In some such examples, by utilizing the data matrix to store and/or transmit data, disclosed examples can reduce utilization of computational resources (e.g., memory, bandwidth) associated with transmission and/or storage of the temperature data and/or the power data.

In the illustrated example of FIG. 1, the model analysis circuitry 104 generates, trains, and/or executes one or more example brake wear prediction models to estimate example brake wear metrics associated with respective brakes 110 of the vehicle 106. In this example, the brake wear prediction model(s) are based on a physics-information neural network (PINN). The model analysis circuitry 104 can generate and/or train the brake wear prediction model(s) based on example training data 116 accessible to the model analysis circuitry 104 (e.g., via the network 114) and/or preloaded in the model analysis circuitry 104. In some examples, the model analysis circuitry 104 accesses the data matrix from the vehicle analysis circuitry 102, obtains and/or extracts the temperature data and the power data from the data matrix, and executes the brake wear prediction model(s) based on the extracted data. As a result of execution of the brake wear prediction model(s), the model analysis circuitry 104 determines and/or outputs the brake wear metric(s) for respective one(s) of the brakes 110 (e.g., and/or the associated brake pads). The brake wear metric(s) can include at least one of a thickness of a brake pad of the corresponding brake(s) 110, a mass of the brake pad, or a change in the thickness or the mass (e.g., relative to a starting thickness and/or a starting mass). In some examples, the model analysis circuitry 104 can estimate, based on the brake wear metric(s), an example remaining useful life (RUL) of the corresponding brake(s) 110. The RUL can be representative of an estimated time until the corresponding brake pads of the brake(s) 110 necessitate replacement.

In some examples, the model analysis circuitry 104 can present, via an example user interface 118 of the vehicle 106, the brake wear metric(s) and/or the estimated RUL to an operator of the vehicle 106. In some examples, the user interface 118 corresponds to a Human Machine Interface (HMI) of the vehicle 106, a display, etc. In some examples, the model analysis circuitry 104 can provide, via the network 114, the brake wear metric(s) and/or the estimate RUL to one or more remote devices (e.g., a mobile device, device(s) that are separate from the vehicle 106, etc.) for presentation thereon. For example, the brake wear metric(s) can be presented, via the remote device(s), to a manufacturer and/or a vehicle service provider to inform and/or assist maintenance activities for the vehicle 106. In some examples, the brake wear metric(s) can be used to inform an operator and/or a vehicle service provider when to replace one or more brake pads of the vehicle 106. Accordingly, disclosed examples can reduce deterioration and/or warping of one or more components (e.g., rotors) of the vehicle 106 resulting from late and/or delayed replacement of the brake pads, and/or can reduce premature replacement of the brake pads.

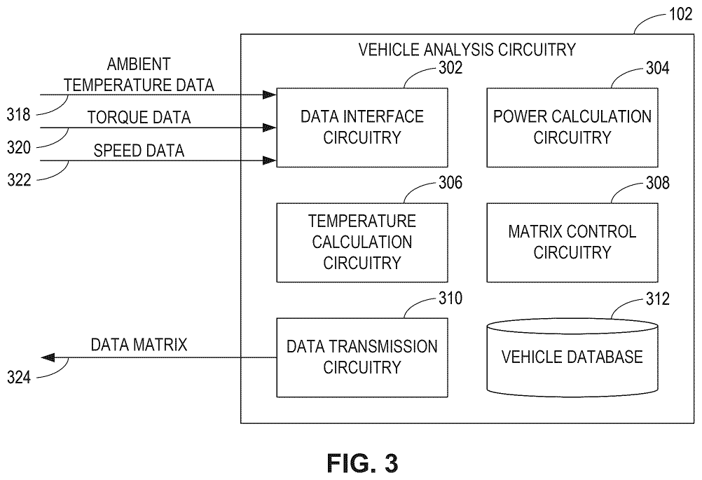

FIG. 3 is a block diagram of an example implementation of the vehicle analysis circuitry 102 of FIG. 1. The vehicle analysis circuitry 102 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the vehicle analysis circuitry 102 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

In the illustrated example of FIG. 3, the vehicle analysis circuitry 102 includes example data interface circuitry 302, example power calculation circuitry 304, example temperature calculation circuitry 306, example matrix control circuitry 308, example data transmission circuitry 310, and an example vehicle database 312.

The vehicle database 312 of FIG. 3 stores data utilized and/or obtained by the vehicle analysis circuitry 102. The example vehicle database 312 of FIG. 3 is implemented by any memory, storage device and/or storage disc for storing data such as, for example, flash memory, magnetic media, optical media, solid state memory, hard drive(s), thumb drive(s), etc. Furthermore, the data stored in the vehicle database 312 may be in any data format such as, for example, binary data, comma delimited data, tab delimited data, structured query language (SQL) structures, etc. While, in the illustrated example, the vehicle database 312 is illustrated as a single device, the vehicle database 312 and/or any other data storage devices described herein may be implemented by any number and/or type(s) of memories.

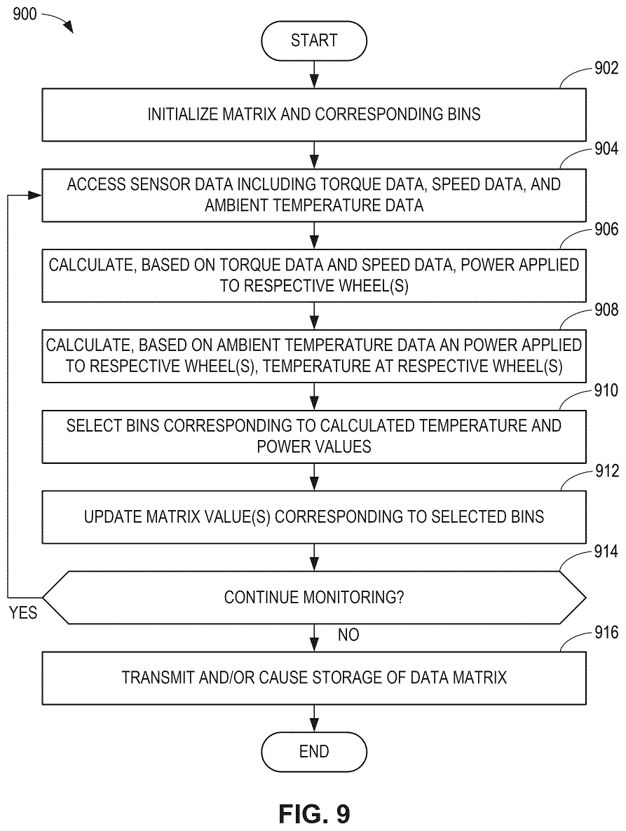

The data interface circuitry 302 of FIG. 3 accesses, retrieves, and/or otherwise obtains example data (e.g., sensor data) to be utilized by the vehicle analysis circuitry 102. For example, the data interface circuitry 302 can obtain, from the sensor(s) 112 of FIG. 1, example ambient temperature data 318, example torque data 320, and/or example speed data 322. In the example of FIG. 3, the ambient temperature data 318 represents an ambient temperature (e.g., in degrees Celsius) in an environment of the vehicle 106 of FIG. 1. In some examples, the torque data 320 represents torque (e.g., in Newton-meters) applied to respective one(s) of the wheels 108. In some examples, the speed data 322 represents a speed (e.g., a travel speed) (e.g., in kilometers per hour) of the vehicle 106. In some examples, the data interface circuitry 302 obtains the sensor data (e.g., the ambient temperature data 318, the torque data 320, and/or the speed data 322) a particular frequency (e.g., every 1 second, every 2 seconds, etc.), where the frequency can be preset in the vehicle analysis circuitry 102 and/or can be selected and/or adjusted by an operator of the vehicle 106. In some examples, the data interface circuitry 302 obtains the sensor data during operation and/or travel of the vehicle 106. In some examples, the data interface circuitry 302 provides the sensor data to the vehicle database 312, where the sensor data can be stored in association with the time(s) at which the sensor data was captured and/or obtained. In some examples, the data interface circuitry 302 is instantiated by programmable circuitry executing data interface circuitry instructions and/or configured to perform operations such as those represented by the flowchart(s) of FIG. 9.

The power calculation circuitry 304 of FIG. 3 calculates, based on the sensor data, example power data associated with the respective wheel(s) 108 and/or brake(s) 110 of the vehicle 106. For example, the power data can represent power (e.g., in Watts (W)) applied by the brakes 110 to one or more of the wheels 108. In some examples the power data can include a total (e.g., combined) power (e.g., P) applied to the wheels 108, and/or can include multiple power values corresponding to individual ones of the wheels 108 (e.g., the front wheels 108A, 108B and/or the rear wheels 108C, 108D). In some examples, the power calculation circuitry 304 calculates the total power (e.g., P) based on example Equation 1 below.

$$P = \frac{τ * V * {c}_{kph \_ to \_ mps}}{r} \qquad ( Equation 1 )$$

In example Equation 1 above, P represents the total power (e.g., in Watts) applied to the wheels 108 at a particular time, τ represents the torque (e.g., in Newton-meters (Nm)) applied to the wheels 108, V represents the speed (e.g. in kilometers per hour (kph)) of the vehicle 106, c_{kph_to_mps} represents a conversion factor from kilometers per hour (kph) to meters per second (mps), and r represents a tire radius (e.g., in meters (m)) of the wheels 108.

In some examples, the power calculation circuitry 304 calculates, based on the total power P, individual power values representative of the power applied to respective ones of the wheels 108. For example, the power calculation circuitry 304 calculates the individual power values based on a first example power ratio (e.g., c_{power_to_left}) representative of a first proportion of the total power that is applied to left-hand side wheels (e.g., the first and third wheels 108A, 108C) of the vehicle 106, and a second example power ratio (e.g., c_{power_to_front}) representative of a second proportion of the total power that is applied to front wheels (e.g., the first and second wheels 108A, 108B) of the vehicle 106. In some examples, the power calculation circuitry 304 calculates a first power (e.g., a front left power) applied to the first wheel 108A (e.g., P_{front_left}), a second power (e.g., a front right power) applied to the second wheel 108B (e.g., P_{front_right}), a third power (e.g., a rear left power) applied to the third wheel 108C (e.g., P_{rear_left}), and a fourth power (e.g., a rear right power) applied to the fourth wheel 108D (e.g., P_{rear_right}) based on example Equations 2A, 2B, 2C, and 2D below, respectively.

$${P}_{front \_ left} = P * {c}_{power \_ to \_ left} * {c}_{power \_ to \_ front} \qquad ( Equation 2 A )$$

$${P}_{front \_ right} = P * ( 1 - {c}_{power \_ to \_ left} ) * {c}_{power \_ to \_ front} \qquad ( Equation 2 B )$$

$${P}_{rear \_ left} = P * {c}_{power \_ to \_ left} * ( 1 - {c}_{power \_ to \_ front} ) \qquad ( Equation 2 C )$$

$${P}_{rear \_ right} = P * ( 1 - {c}_{power \_ to \_ left} ) * ( 1 - {c}_{power \_ to \_ front} ) \qquad ( Equation 2 D )$$

In example Equations 2A, 2B, 2C, and/or 2D above, P_{front_left} represents the front left power, P_{front_right} represents the front right power, P_{rear_left} represents the rear left power, P_{rear_right} represents the rear right power, P represents the total power, c_{power_to_front} represents the proportion of the total power applied to the front wheels 108A, 108B, and c_{power_to_left} represents the proportion of the total power applied to the left wheels 108A, 108C.

In the example of FIG. 3, c_{power_to_front}=0.5, meaning that the power applied to the front wheels 108A, 108B is equal to the power applied to the rear wheels 108C, 108D (e.g., the total power is split evenly between the front wheels 108A, 108B and the rear wheels 108C, 108D). Similarly, in this example, c_{power_to_left}=0.5, meaning that the power applied to the left-hand side wheels 108A, 108C is equal to the power applied to the right-hand side wheels 108B, 108D (e.g., the total power is split evenly between the left-hand side wheels 108A, 108C and the right-hand side wheels 108B, 108D). In some examples, the first proportion (e.g., c_{power_to_front}) and/or the second proportion (e.g., c_{power_to_left}) may be different (e.g., at least 0 and up to and including 1). For example, the first proportion and/or the second proportion may be adjusted by an operator of the vehicle 106 (e.g., via user input to the user interface 118 of FIG. 1) and/or may vary based on a model and/or type of the vehicle 106. In some examples, after calculating the power data (e.g., the power applied to respective one(s) of the wheels 108), the power calculation circuitry 304 provides the power data to the matrix control circuitry 308 for use in generating and/or updating a data matrix. In some examples, the power calculation circuitry 304 is instantiated by programmable circuitry executing power calculation circuitry instructions and/or configured to perform operations such as those represented by the flowchart(s) of FIG. 9.

The temperature calculation circuitry 306 of FIG. 3 calculates, based on the sensor data and/or based on the calculated power values from the power calculation circuitry 304, example temperature data associated with respective one(s) of the wheels 108. For example, the temperature data can represent temperature(s) of the respective wheel(s) 108 (e.g., at or near an interface between the brake(s) 110 and the corresponding rotor(s) of the respective wheel(s) 108). In some examples, the temperature calculation circuitry 306 calculates a front wheel temperature (e.g., T_{front}) for one(s) of the front wheels 108A, 108B based on example Equation 3A below.

$${T}_{front} = \frac{dt}{m {C}_{rear}} * ( {P}_{front} - c {F}_{front} * ( {T}_{front , prev} - {T}_{ambient} ) ) + {T}_{front , prev} \qquad ( Equation 3 A )$$

In example Equation 3A above, T_{front} represents the front wheel temperature (e.g., in Celsius) at a current time, P_{front} represents the power applied to the front wheel (e.g., in Watts) as determined by the power calculation circuitry 304, m represents a mass (e.g., in kilograms) of the brake pad associated with the front wheel, C_{front} represents a specific heat capacity (e.g., in joules per kilogram per degree Celsius (J/kg° C.)) corresponding to a material of a rotor associated with the front wheel, cF_{front} represents a convective heat transfer factor (e.g., in Watts per Kelvin (W/K)) corresponding to the material of the rotor, T_{ambient} represents the ambient temperature (e.g., from the ambient temperature data 318), T_{front,prev} represents a previous front wheel temperature at a previous time (e.g., prior to the current time), and dt represents a difference (e.g., a duration) between the previous time and the current time. In some examples, the ambient temperature is initially selected as the previous front wheel temperature (e.g., when the previous front wheel temperature is unavailable and/or unknown, upon startup of the vehicle 106, etc.). In this example, the rotor of the front wheel includes steel, such that the specific heat capacity (e.g., C_{front}) is 420 J/kg° C., and the heat transfer factor (e.g., cF_{front}) is between 0.001 W/K and 0.005 W/K. In some examples, different value(s) may be used for the specific heat capacity and/or the heat transfer coefficient (e.g., when a different material is used for the rotor).

In some examples, the temperature calculation circuitry 306 can further calculate a rear wheel temperature (e.g., Tᵣₑₐᵣ) for one(s) of the rear wheels 108C, 108D based on example Equation 3B below.

$${T}_{rear} = \frac{dt}{m {C}_{rear}} * ( {P}_{rear} - c {F}_{rear} * ( {T}_{rear , prev} - {T}_{ambient} ) ) + {T}_{rear , prev} \qquad ( Equation 3 B )$$

Example Equation 3B above is similar to example Equation 3A above, except that subscripts of the variables in Equation 3B have been changed (e.g., relative to Equation 3A above) to correspond to the rear wheel(s) 108C, 108D. Thus, descriptions of the variables described in Equation 3A above can apply equally to the variables shown in Equation 3B above, with respect to the rear wheel(s) 108C, 108D. In some examples, after calculating the temperature data (e.g., the front wheel temperature(s) and/or the rear wheel temperature(s)) for respective one(s) of the wheels 108, the temperature calculation circuitry 306 provides the temperature data to the matrix control circuitry 308 for use in generating and/or updating a data matrix. In some examples, the temperature calculation circuitry 306 is instantiated by programmable circuitry executing temperature calculation circuitry instructions and/or configured to perform operations such as those represented by the flowchart(s) of FIG. 9.

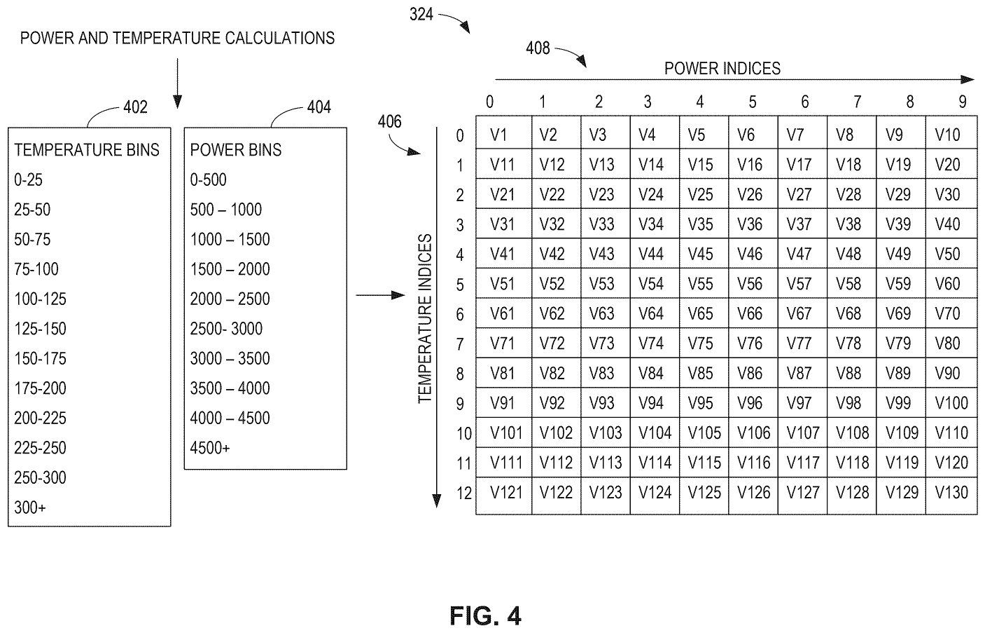

The matrix control circuitry 308 can generate, based on the power data and the temperature data, an example data matrix (e.g., a histogram matrix) 324 for efficient storage and/or transmission of the power data and the temperature data. For example, FIG. 4 illustrates the example data matrix 324 that may be generated by the matrix control circuitry 308. To generate the data matrix 324 of FIG. 4, the matrix control circuitry 308 selects and/or defines example temperature bins 402 and example power bins 404. The temperature bins 402 correspond to respective different ranges of temperature values that may be represented in the temperature data. In FIG. 4, the matrix control circuitry 308 defines twelve of the temperature bins 402, where eleven of the temperature bins 402 represent a range from 0 degrees (e.g., Celsius) up to (but not including) 300 degrees, and a twelfth one of the temperature bins 402 represents a range of 300 degrees and above. Stated differently, the temperature bins 402 include a first temperature bin corresponding to a first example range of temperature values (e.g., from 0 degrees up to but not including 25 degrees), a second temperature bin corresponding to a second example range of temperature values (e.g., from 25 degrees up to but not including 50 degrees), and so forth.

Further, the power bins 404 correspond to respective different ranges of power values that may be represented in the power data. In FIG. 4, the matrix control circuitry 308 defines nine of the power bins 404, where eight of the power bins 404 represent a range from 0 Watts (W) up to (but not including) 4500 W, and a ninth one of the power bins 404 represents a range of 4500 W and above. Stated differently, the power bins 404 include a first power bin corresponding to a first example range of power values (e.g., from 0 W up to but not including 500 W), a second power bin corresponding to a second example range of power values (e.g., from 500 W up to but not including 1000 W), and so forth. While twelve of the temperature bins 402 and nine of the power bins 404 are shown in FIG. 4, a different number of the temperature bins 402 and/or the power bins 404 may be used instead. Additionally, one or more of the example ranges for the respective temperature and power bins 402, 404 shown in FIG. 4 may be different in some examples. In some examples, the number of the bins 402, 404 and/or the associated ranges can be preloaded in the matrix control circuitry 308, and/or may be selected and/or adjusted based on user input (e.g., provided via the user interface 118 of FIG. 1).

In the illustrated example of FIG. 4, the matrix control circuitry 308 generates and/or initializes the data matrix 324 based on the temperature and power bins 402, 404. For example, the matrix control circuitry 308 selects a size (e.g., a row count and a column count) of the data matrix 324 based on bin counts of the temperature and power bins 402, 404. In the example of FIG. 4, the matrix control circuitry 308 generates the data matrix 324 having twelve rows 406 (e.g., corresponding to the temperature bins 402) and nine columns 408 (e.g., corresponding to the power bins 404). While the rows 406 correspond to the temperature bins 402 and the columns 408 correspond to the power bins 404 in this example, the rows 406 and the columns 408 may be reversed in some examples (e.g., such that the rows 406 correspond to the power bins 404 and the columns 408 correspond to the temperature bins 404).

In the example of FIG. 4, example temperature indices are used to represent the respective rows 406 of the data matrix 324, and the temperature indices further correspond to respective ones of the temperature bins 402. Similarly, example power indices are used to represent the respective columns 408 of the data matrix 324, and the power indices further correspond to respective ones of the power bins 404. In some examples, matrix values (e.g., elements) of the data matrix 324 can be represented by the corresponding temperature and power indices. For example, a first matrix value (e.g., represented as V21 in FIG. 4) corresponds to a temperature index of 2 (e.g., further corresponding to a temperature bin range of 50 to 75) and a power index of 0 (e.g., further corresponding to a power bin range of 0 to 500). In some examples, the matrix values represent respective quantities (e.g., counts) of data samples corresponding to the respective temperature and power bins. In this example, a data sample corresponds to the sensor data (e.g., the ambient temperature data 318, the torque data 320, and/or the speed data 322 of FIG. 3) captured and/or obtained at a given time.

In the illustrated example of FIG. 4, the matrix control circuitry 308 updates the matrix values of the data matrix 324 based on one or more data samples obtained by the vehicle analysis circuitry 102 of FIGS. 1 and/or 3. For example, during operation and/or travel of the vehicle 106, the vehicle analysis circuitry 102 can collect and/or obtain the data samples at a given frequency (e.g., every 1 second, every 2 seconds, etc.). In some examples, after the temperature and power values are calculated (e.g., by the temperature calculation circuitry 306 and the power calculation circuitry 304, respectively) for a given data sample, the matrix control circuitry 308 selects one of the temperature bins 402 to which the calculated temperature value corresponds, and selects one of the power bins 404 to which the calculated power value corresponds. For example, when the data sample corresponds to a temperature of 55 degrees and a power of 560 W, the matrix control circuitry 308 determines that the data sample corresponds to a third one of the temperature bins 402 (e.g., associated with a temperature range of 50 degrees to 75 degrees) and further corresponds to a second one of the power bins 404 (e.g., associated with a power range of 500 W to 1000 W). In such examples, the matrix control circuitry 308 selects the temperature and power indices (e.g., a temperature index of 2 and a power index of 1) corresponding to the selected temperature and power bins 402, 404, then increments (e.g., by 1) one of the matrix values corresponding to the selected temperature and power indices.

In some examples, the matrix control circuitry 308 updates the data matrix 324 (e.g., by continuously and/or periodically incrementing one(s) of the matrix values) based on additional data samples collected and/or obtained during operation of the vehicle 106. For example, the matrix control circuitry 308 can monitor and/or update the data matrix 324 for a duration of a trip and/or operation by the vehicle 106. In some examples, the matrix control circuitry 308 can monitor and/or update the data matrix 324 for a preselected duration (e.g., selected based on user input). In some examples, the matrix control circuitry 308 can generate and/or update multiple ones of the data matrix 324, where the multiple data matrices 324 can correspond to individual one(s) of the wheels 108, can correspond to the front wheels 108A, 108B and the rear wheels 108C, 108D separately, etc. In some examples, the matrix control circuitry 308 can provide the data matrix 324 (and/or the multiple data matrices) to the vehicle database 312 for storage therein. In some examples, by storing the data matrix 324 (e.g., instead of the individual temperature and power values for the respective data samples), disclosed examples can reduce utilization of computational resources (e.g., memory) for data storage. In some examples, the matrix control circuitry 308 is instantiated by programmable circuitry executing matrix control circuitry instructions and/or configured to perform operations such as those represented by the flowchart(s) of FIG. 9.

Returning to FIG. 3, the data transmission circuitry 310 sends, transmits, and/or otherwise provides data from the vehicle analysis circuitry 102 to the model analysis circuitry 104 of FIG. 1. For example, the data transmission circuitry 310 can send the data matrix 324 (e.g., generated by the matrix control circuitry 308) to the model analysis circuitry 104 via the network 114 of FIG. 1. In some examples, the data transmission circuitry 310 sends and/or transmits example metadata associated with the data matrix 324, where the metadata can include time(s) at which the data matrix 324 was generated and/or time(s) at which the sensor data (e.g., the ambient temperature data 318, the torque data 320, and/or the speed data 322) was obtained. In some examples, the data transmission circuitry 310 sends the data matrix 324 (and/or the associated metadata) periodically (e.g., once per day, etc.) and/or after completion of a trip or operation by the vehicle 106. In some examples, by using the data matrix 324 to send calculated temperature and power values (e.g., the temperature data and the power data) over the network 114, disclosed examples reduce bandwidth utilization (e.g., compared to when the temperature and power data is sent directly via the network 114). In some examples, the data transmission circuitry 310 is instantiated by programmable circuitry executing data transmission circuitry instructions and/or configured to perform operations such as those represented by the flowchart(s) of FIG. 9.

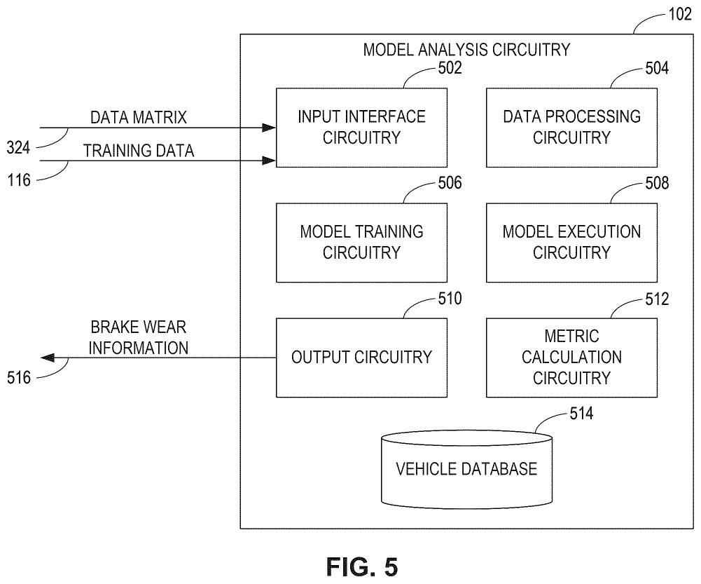

FIG. 5 is a block diagram of an example implementation of the model analysis circuitry 104 of FIG. 1. The model analysis circuitry 104 of FIG. 5 may be instantiated (e.g., creating an instance of, bring into being for any length of time, materialize, implement, etc.) by programmable circuitry such as a Central Processor Unit (CPU) executing first instructions. Additionally or alternatively, the model analysis circuitry 104 of FIG. 5 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 5 may, thus, be instantiated at the same or different times. Some or all of the circuitry of FIG. 5 may be instantiated, for example, in one or more threads executing concurrently on hardware and/or in series on hardware. Moreover, in some examples, some or all of the circuitry of FIG. 5 may be implemented by microprocessor circuitry executing instructions and/or FPGA circuitry performing operations to implement one or more virtual machines and/or containers.

In the illustrated example of FIG. 5, the model analysis circuitry 104 includes example input interface circuitry 502, example data processing circuitry 504, example model training circuitry 506, example model execution circuitry 508, example output circuitry 510, example metric calculation circuitry 512, and an example cloud database 514.

The cloud database 514 of FIG. 5 stores data utilized and/or obtained by the model analysis circuitry 104. The example cloud database 514 of FIG. 5 is implemented by any memory, storage device and/or storage disc for storing data such as, for example, flash memory, magnetic media, optical media, solid state memory, hard drive(s), thumb drive(s), etc. Furthermore, the data stored in the cloud database 514 may be in any data format such as, for example, binary data, comma delimited data, tab delimited data, structured query language (SQL) structures, etc. While, in the illustrated example, the cloud database 514 is illustrated as a single device, the cloud database 514 and/or any other data storage devices described herein may be implemented by any number and/or type(s) of memories.

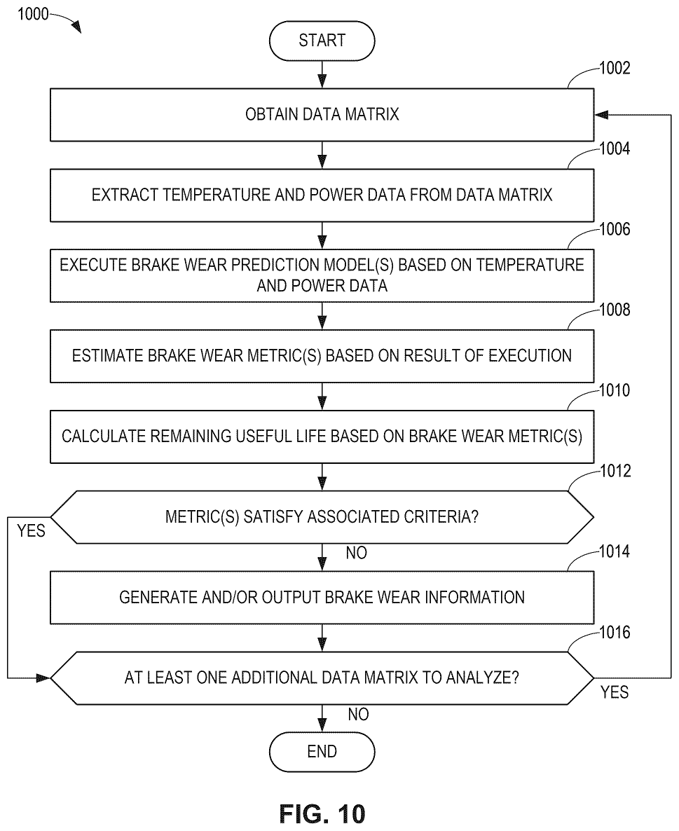

The input interface circuitry 502 of FIG. 5 accesses, retrieves, and/or otherwise obtains data to be utilized by the model analysis circuitry 104. For example, the input interface circuitry 502 obtains, via the network 114 of FIG. 1, the data matrix 324 generated by the vehicle analysis circuitry 102 of FIGS. 1 and/or 3. Further, the input interface circuitry 502 can obtain the training data 116 via the network 114. In some examples, the training data 116 can be preloaded in the model analysis circuitry 104. In some examples, the input interface circuitry 502 provides the data matrix 324 and/or the training data 116 to the cloud database 514 for storage therein. In some examples, the input interface circuitry 502 is instantiated by programmable circuitry executing input interface circuitry instructions and/or configured to perform operations such as those represented by the flowchart(s) of FIGS. 10 and/or 11.

The data processing circuitry 504 of FIG. 5 processes the data (e.g., the data matrix 324 and/or the training data 116) obtained by the input interface circuitry 502. For example, the data processing circuitry 504 can extract and/or determine, from the data matrix 324, power values and temperature values (and/or ranges of the power values and temperature values) associated with the respective wheel(s) 108 of the vehicle 106 of FIG. 1. In some examples, the data processing circuitry 504 can pre-process the training data 116 by, for example, removing duplicate data samples from the training data 116. In some examples, the data processing circuitry 504 selects and/or generates collocation points for use in training and/or evaluating one or more example brake wear prediction models (e.g., physics-informed neural network (PINN) model(s)). For example, the data processing circuitry 504 selects the collocation points from an input space (e.g., a multi-dimensional space, a sample space) defined based on an input temperature range, an input power range, and an input time range. In such examples, the input temperature range represents a first range of expected (e.g., possible) temperature values for the brake pads of the brake(s) 110, the input power range represents a second range of expected (e.g., possible) power values that may be applied by the brake pads onto respective rotors of the wheel(s) 108, and the input time range represents expected (e.g., possible) times (e.g., durations) for which the brake(s) 110 are expected to operate (e.g., durations for which the brake(s) 110 are applied or operated to decelerate the vehicle 106). In some examples, the input temperature range, the input power range, and the input time range are selected based on user input (e.g., defining minimum and/or maximum values for the respective range(s)) and/or can be preloaded in the model analysis circuitry 104 (e.g., in the cloud database 514). In this example, the number of collocation points corresponds to (e.g., is equal to) a number of data samples represented in the training data 116. In some examples, a different number of the collocation points (e.g., greater than or less than the number of data samples represented in the training data 116) may be used instead.

In some examples, for a given one of the collocation points, the data processing circuitry 504 selects a temperature value from the input temperature range, a power value from the input power range, and a time value from the input time range. In some examples, the data processing circuitry 504 selects the collocation points from the input space based on a Latin hypercube sampling method. In some examples, a different sampling method (e.g., random sampling, full factorial sampling, Sobol sampling, etc.) may be used instead. In some examples, the data processing circuitry 504 provides the collocation points to the cloud database 514 for storage therein. In some examples, the data processing circuitry 504 is instantiated by programmable circuitry executing data processing circuitry instructions and/or configured to perform operations such as those represented by the flowchart(s) of FIG. 10.

The model training circuitry 506 of FIG. 5 generates, trains, and/or re-trains one or more example brake wear prediction models (e.g., physics-informed neural network (PINN) model(s)) to predict brake pad wear (e.g., brake wear metric(s)) corresponding to the respective brakes 110 of the vehicle 106. For example, the model training circuitry 506 can generate and/or train the brake wear prediction model(s) based on the training data 116.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

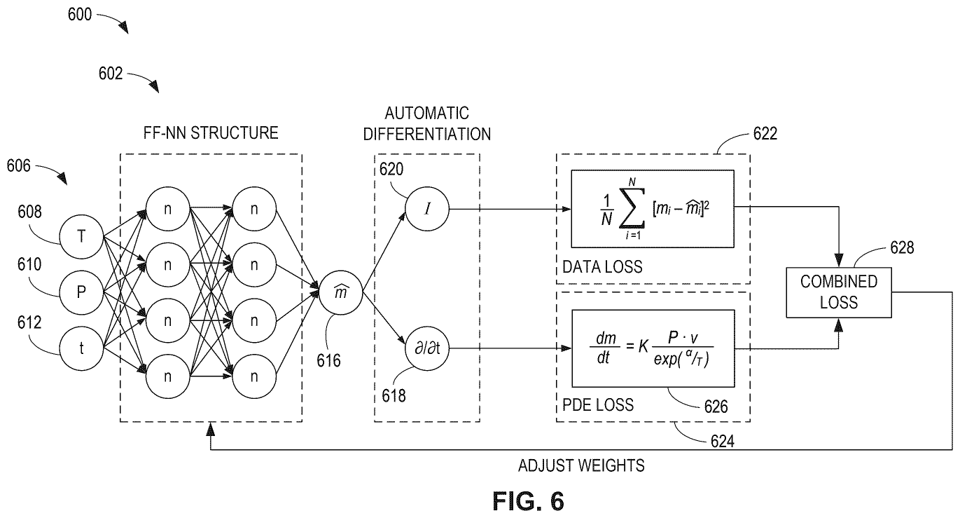

Many different types of machine learning models and/or machine learning architectures exist. In examples disclosed herein, a physics-information neural network (PINN) model is used. Using a PINN model enables training based on available training data (e.g., the training data 116) and further based on known and/or expected physical behavior (e.g., dynamic behavior) of an underlying system. In some examples, because PINN models are trained based on expected dynamic behavior (e.g., represented using one or more equations) in addition to labelled training data, PINN models can be used with inputs and/or outputs not represented in the training data 116 (e.g., that fall outside of a range of the inputs and/or outputs represented in the training data 116). Stated differently, while the training data 116 may represent a particular range of temperature and power values, the PINN models can be trained to accurately predict brake wear metric(s) for temperature and power values that fall outside of (e.g., that are greater than or less than) that particular range. As a result, the PINN model may be trained using less training data compared to other machine learning models. Training and/or generation of the PINN model is described further below in connection with FIG. 6.

In general, machine learning models/architectures that are suitable to use in the example approaches disclosed herein will be neural networks. However, other types of machine learning models could additionally or alternatively be used. In general, implementing a ML/AI system involves two phases, a learning/training phase and an inference phase. In the learning/training phase, a training algorithm is used to train a model to operate in accordance with patterns and/or associations based on, for example, training data (e.g., the training data 116 of FIG. 5). In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained using stochastic gradient descent. However, any other training algorithm may additionally or alternatively be used. In examples disclosed herein, training is performed until an acceptable amount of error is achieved (e.g., one or more loss values associated with an output of the model(s) satisfy a threshold). In examples disclosed herein, training is performed at the model analysis circuitry 104, which may be implemented in a cloud-based environment. Training is performed using hyperparameters that control how the learning is performed (e.g., a learning rate, a number of layers to be used in the machine learning model, etc.). In some examples re-training may be performed. Such re-training may be performed in response to additional training data becoming available. For example, the additional training data may increase prediction error associated with the ML/AI models and, as a result, may trigger re-training for the ML/AI models.

Training is performed using the training data 116. In examples disclosed herein, the training data 116 originates from simulation data and/or testing data. For example, the training data 116 can be obtained based on computer simulation data based on finite element analysis of a brake pad subject to varying conditions (e.g., varying power applied, varying temperatures, etc.). Additionally or alternatively, the training data 116 can be obtained based on dynamic testing of one or more brakes, during which the brake(s) are subject to varying braking conditions (e.g., power applied, temperatures, etc.) and the resulting brake wear metric(s) (e.g., mass and/or width of the brake pad(s)) are measured at selected intervals. In some examples, the training data 116 can be obtained based on vehicle testing of a vehicle and measuring the brake wear metric(s) associated with the vehicle at selected intervals. Because supervised training is used, the training data 116 is labeled. For example, data samples (e.g., including a temperature value, a power value, and/or a time) represented in the training data 116 can be labelled with an indication of the corresponding brake wear metric(s) (e.g., the mass and/or width of a corresponding brake pad). Labeling is applied to the training data manually (e.g., by one or more operators) and/or automatically (e.g., by the model training circuitry 506). In some examples, the training data is sub-divided into a training dataset and a validation dataset.

Once training is complete, the model is deployed for use as an executable construct that processes an input and provides an output based on the network of nodes and connections defined in the model. In some examples, the model is stored in a cloud-based storage environment (e.g., at the cloud database 514 of FIG. 5). The model may then be executed by the model execution circuitry 508 for use in predicting brake pad wear.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

FIG. 6 is a process flow diagram representative of an example model training architecture (e.g., a PINN model architecture) 600 that may be implemented by the model training circuitry 506 to generate and/or train the brake wear prediction model(s). In the illustrated example of FIG. 6, the model training circuitry 506 initializes (e.g., selects initial weights for) an example neural network 602 to be utilized for the brake wear prediction model(s). In this example, the neural network 602 is a feedforward neural network (FNN) with example nodes 604 arranged in a plurality of layers. In FIG. 6, a portion of the neural network 602 is shown having two layers and four of the nodes 604 per layer. In some examples, a different number of the layers and/or the nodes 604 may be used instead (e.g., four layers with fifty of the nodes 604 per layer, etc.).

In the illustrated example of FIG. 6, the model training circuitry 506 provides a portion of the training data 116 as an example input 606 to the neural network 602. For example, the input 606 can include one or more example temperature values (e.g., T) 608, corresponding power value(s) (e.g., P) 610, and corresponding time(s) (e.g., t) 612 represented in the training data 116 (e.g., the time(s) at which the temperature value(s) 608 and/or the power value(s) 610 were measured and/or obtained (e.g., relative to a start time)). In some examples, the temperature value(s) 608, the power value(s) 610, and/or the time(s) 612 can be represented in vector and/or matrix format.

In some examples, the model training circuitry 506 executes the neural network 602 based on the input 606. As a result of the execution, the model training circuitry 506 determines one or more example predicted mass values (e.g., m) 616 corresponding to the input 606. For example, the predicted mass value(s) 616 represent a predicted mass of a brake pad at the corresponding time(s) 612. In FIG. 6, the model training circuitry 506 can perform partial differentiation (e.g., automatic differentiation) to evaluate a partial derivative (e.g., a gradient) of the predicted mass value(s) 616 with respect to time. For example, the model training circuitry 506 performs automatic differentiation to determine and/or estimate a partial derivative 618 (e.g., with respect to time) corresponding to the predicted mass 616. Further, the model training circuitry 506 determines a product of the predicted mass 616 and an identity function 620.

In the illustrated example of FIG. 6, the model training circuitry 506 determines a first example loss value (e.g., a data-based loss value) 622 and a second example loss value (e.g., a physics-based loss value, a partial differential equation (PDE) loss value) 624 associated with the neural network 602. In some examples, the first loss value 622 is based on differences between the predicted mass value(s) 616 and corresponding measured and/or simulated mass value(s) (e.g., ground truth mass value(s)) represented in the training data 116. In some examples, the model training circuitry 506 determines the first loss value 622 based on example Equation 4 below.

$$L = \frac{1}{N} {\sum }_{i = 1}^{N} {[ {m}_{i} - {\hat{m}}_{i} ]}^{2} \qquad ( Equation 4 )$$

In example Equation 4 above, L represents the first loss value 622, mᵢ represents the measured and/or simulated mass corresponding to an i-th data sample, \hat{m}ᵢ represents the predicted mass 616 corresponding to the i-th data sample (e.g., predicted based on the input values 606 from the i-th data sample), and N represents a total number (e.g., a total quantity) of data samples represented in the training data 116.

In the illustrated example of FIG. 6, the model training circuitry 506 determines the second loss value 624 based on differences between first results based on evaluation of the partial derivative 618 at the collocation points (e.g., the collocation points selected and/or generated by the data processing circuitry 504) and second results based on evaluation of an example physics-based equation 626 at the collocation points. In some examples the physics-based equation 626 is representative of known and/or expected dynamics for wear of a material. In this example, the physics-based equation 626 is based on the Archard equation for wear dynamics, where the physics-based equation is a function of temperature and power. In some examples, a different physics-based equation may be used instead. In the example of FIG. 6, the model training circuitry 506 evaluates, at the collocation points, the physics-based equation 626 corresponding to example Equation 5 below.

$$\frac{d \hat{m}}{dt} = K \frac{P \cdot v}{exp ( \frac{α}{T} )} \qquad ( Equation 5 )$$

In example Equation 5 above,

$$\frac{d \hat{m}}{dt}$$

represents a calculated mass rate of change, P represents the power value (e.g., corresponding to a given collocation point), T represents the temperature value (e.g., corresponding to the given collocation point), v represents a vehicle speed (e.g., speed of the vehicle 106 of FIG. 1), and K and α are constants corresponding to a material of the brake pads of the brake(s) 110. Stated differently, the calculated mass rate of change is proportional to a ratio between the power value and the temperature value for a given collocation point. In some examples, K corresponds to a value of at least 1 and up to 4, and α corresponds to a value of at least 10000 and up to 30000.

In the illustrated example of FIG. 6, the model training circuitry 506 evaluates example Equation 5 above at respective collocation points to determine the calculated mass rates of change

$$( e . g . , \frac{d \hat{m}}{dt} )$$

corresponding to the respective collocation points. Further, the model training circuitry 506 evaluates the partial derivative 618 at the respective collocation points to determine predicted mass rates of change

$$( e . g . , \frac{\partial \hat{m}}{\partial t} )$$

corresponding to the respective collocation points. In some examples, the model training circuitry 506 determines the second loss value 624 based on a difference (e.g., an average difference) between the calculated mass rates and the corresponding predicted mass rates. Further, the model training circuitry 506 determines an example combined loss value 628 based on the first and second loss values 622, 624. For example, the model training circuitry 506 can determine the combined loss value 628 based on a combination (e.g., an aggregate, a sum) of the first and second loss values 622, 624. In the example of FIG. 6, the model training circuitry 506 adjusts weights of the neural network 602 based on the combined loss value 628.

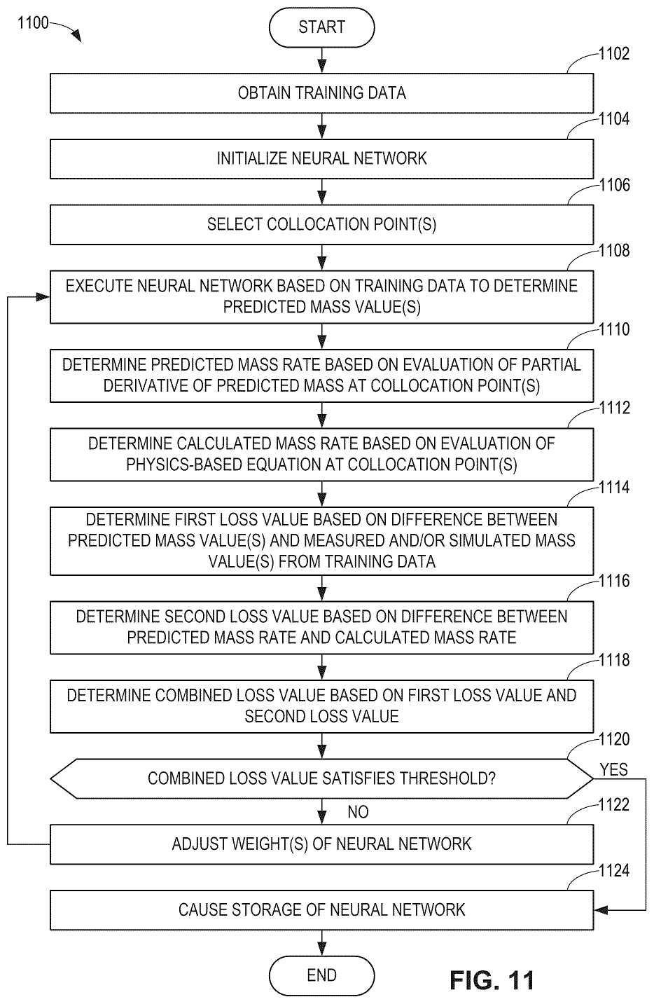

In some examples, the model training circuitry 506 continues to train the neural network 602 (e.g., by adjusting weight(s) of the neural network 602) until the combined loss value 628 determined based on execution of the neural network 602 satisfies an example threshold (e.g., an error threshold). For example, when the combined loss value 628 does not satisfy (e.g., is greater than) the error threshold, the model training circuitry 506 adjusts the weights of the neural network 602, and re-executes the updated neural network 602 with the adjusted weights. Conversely, when the combined loss value 620 satisfies (e.g., is less than or equal to) the error threshold, the model training circuitry 506 generates the brake wear prediction model(s) based on the trained neural network 602, then provides the brake wear prediction model(s) to the cloud database 514 for storage therein and/or for execution by the model execution circuitry 508. In some examples, the model training circuitry 506 is instantiated by programmable circuitry executing model training circuitry instructions and/or configured to perform operations such as those represented by the flowchart(s) of FIG. 11.

Returning to FIG. 4, the model execution circuitry 508 executes the brake wear prediction model(s) generated and/or trained by the model training circuitry 506. For example, the model execution circuitry 508 can execute the brake wear prediction model(s) based on the temperature data and/or the power data extracted from the data matrix 324. As a result of the execution, the model execution circuitry 508 determines and/or estimates one or more example brake wear metrics (e.g., brake pad wear metric(s)) corresponding to respective one(s) of the brakes 110 of FIG. 1. For example, the brake wear metric(s) can include at least one of a mass, a thickness (e.g., a width), and/or a change in mass and/or thickness (e.g., relative to a starting mass and/or thickness) of a brake pad associated with the respective one(s) of the brakes 110. In some examples, the mass corresponds to an output of the executed brake wear prediction model(s), and the model execution circuitry 508 further determines the thickness based on the mass, a density of the material used for the brake pads, and/or a geometry (e.g., a surface area) of the brake pads. In some examples, the model execution circuitry 508 provides the brake wear metric(s) to the cloud database 514 for storage therein, where the brake wear metric(s) can be stored in association with identifier(s) corresponding to the respective brake(s) 110 and/or in association with the time(s) for which the brake wear metric(s) were determined. In some examples, the model execution circuitry 508 is instantiated by programmable circuitry executing model execution circuitry instructions and/or configured to perform operations such as those represented by the flowchart(s) of FIG. 10.

The metric calculation circuitry 512 of FIG. 5 can predict and/or determine, based on the brake wear metric(s), a remaining useful life (RUL) (e.g., an RUL metric) associated with the brake pads of the respective brake(s) 110. In some examples, the RUL represents a remaining width of the brake pads. In some examples, the RUL represents a duration for which the brake pads may be utilized before replacement of the brake pads is necessary (e.g., to avoid deterioration of braking efficiency of the brake(s) 110). In some examples, the metric calculation circuitry 512 calculates the RUL based on example Equation 6 below.

$$RUL = {w}_{current} - Δ w \qquad ( Equation 6 )$$

In example Equation 6 above, RUL represents the RUL corresponding to one or more brake pads of a corresponding one of the brakes 110 of FIG. 1, w_{current} represents a current (e.g., measured) width of the brake pad(s) (e.g., from a last measured brake pad width of the brake pad(s)), and Δw represents estimated wear (e.g., loss of width) of the brake pad(s) predicted based on a result of execution of the brake wear prediction model(s). In some examples, the metric calculation circuitry 512 calculates the RUL(s) corresponding to respective one(s) of the brakes 110, and provides the calculated RUL(s) to the cloud database 514 for storage therein. In some examples, the metric calculation circuitry 512 is instantiated by programmable circuitry executing metric calculation circuitry instructions and/or configured to perform operations such as those represented by the flowchart(s) of FIG. 10.

The output circuitry 510 outputs information (e.g., example brake wear information 516) generated, determined, and/or obtained by the model analysis circuitry 104. For example, the brake wear information 516 can include the brake wear metric(s) determined for respective one(s) of the brakes 110. In some examples, the brake wear information 516 can include one or more timestamps associated with the brake wear metric(s) (e.g., representative of the time(s) for which the brake wear metric(s) were determined, the time(s) at which sensor data used for determining the brake wear metric(s) was collected, etc.). In some examples, the output circuitry 510 can send and/or transmit (e.g., via the network 114 of FIG. 1) the brake wear information 516 to the vehicle 106 of FIG. 1 to cause presentation (e.g., display) of the brake wear information 516 via the user interface 118. Additionally or alternatively, the output circuitry 510 can send and/or transmit the brake wear information 516 to a manufacturer of the vehicle 106, to a service provider of the vehicle 106, etc. In such examples, the brake wear information 516 can be utilized (e.g., by an owner of the vehicle 106, by the manufacturer and/or the service provider of the vehicle 106, etc.) to plan and/or adjust maintenance activities (e.g., replacement of brake pads of the brake(s) 110) for the vehicle 106.

In some examples, the output circuitry 510 sends and/or transmits the brake wear information 516 periodically (e.g., once per pay, once every two days, etc.). In some examples, the output circuitry 510 sends and/or transmits the brake wear information 516 when the brake wear metric(s) and/or the predicted RUL(s) do not satisfy example criteria (e.g., brake performance criteria, brake wear threshold(s)). For example, the output circuitry 510 can send the brake wear information 516 when the predicted mass of the brake pad(s) is less than a threshold mass, when the predicted width of the brake pad(s) is less than a threshold width, when the predicted RUL(s) are less than a threshold RUL, etc. In some examples, the output circuitry 510 is instantiated by programmable circuitry executing output circuitry instructions and/or configured to perform operations such as those represented by the flowchart(s) of FIG. 10.

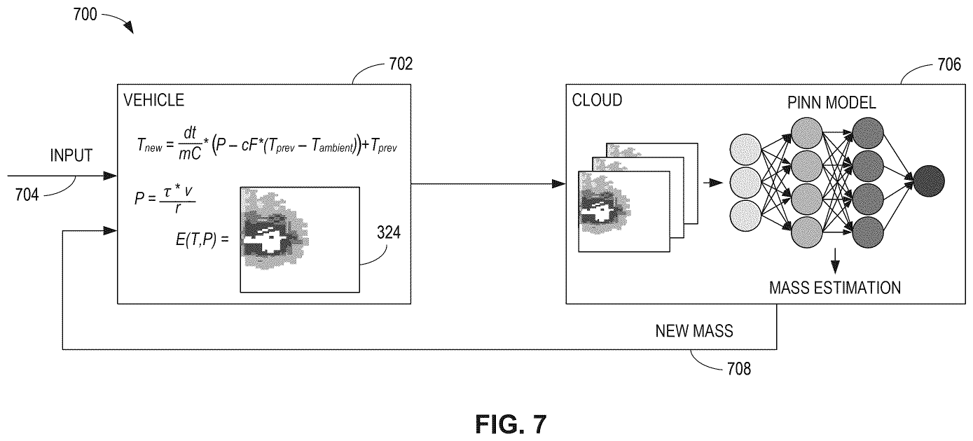

FIG. 7 is a process flow diagram 700 representative of an example information exchange procedure that may be implemented by the example vehicle analysis circuitry 102 of FIGS. 1 and/or 3 and the example model analysis circuitry 104 of FIGS. 1 and/or 5. In the illustrated example of FIG. 7, at an example vehicle block 702, the vehicle analysis circuitry 102 obtains example input 704 including the ambient temperature data 318, the torque data 320, and/or the speed data 322. Further, the vehicle analysis circuitry 102 calculates and/or determines example power data and example temperature data based on the input 704, then generates and/or updates one or more data matrices (e.g., the data matrix 324) based on the power data and the temperature data. In some examples, the vehicle analysis circuitry 102 provides the data matrix 324 to the model analysis circuitry 104 (e.g., implemented in a cloud-based environment).

At an example cloud block 706, the model analysis circuitry 104 executes one or more brake wear prediction model(s) (e.g., PINN model(s), machine learning model(s)) based on the power data and the temperature data obtained from the one or more data matrices from the vehicle analysis circuitry 102. In some examples, based on a result of the execution, the model analysis circuitry 104 determines and/or estimates an example mass (e.g., a brake pad mass) 708 of one or more brake pads of the vehicle 106 of FIG. 1. In some examples, the model analysis circuitry 104 provides the determined mass 708 to the vehicle analysis circuitry 102 for use in calculating updated power and temperature data based on new (e.g., incoming) input 704. In some examples, the information exchange procedure of FIG. 7 is performed repeatedly and/or periodically during a life of the brake pads of the vehicle 106 to monitor wear of the brake pads and, thus, to inform maintenance and/or replacement activities for the brake pads.

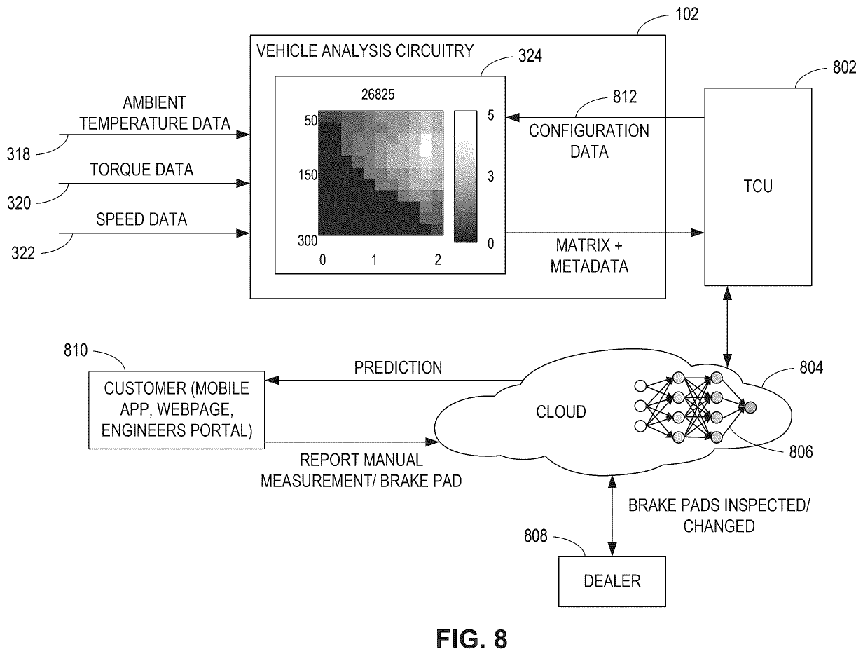

FIG. 8 is a process flow diagram 800 representative of an example brake wear prediction procedure that may be implemented by the vehicle analysis circuitry 102 of FIGS. 1 and/or 3 and/or the model analysis circuitry 104 of FIGS. 1 and/or 5. In the illustrated example of FIG. 8, the vehicle analysis circuitry 102 accesses and/or obtains sensor data including the ambient temperature data 318, the torque data 320, and the speed data 322, and generates the data matrix 324 based on the sensor data. In this example, the vehicle analysis circuitry 102 is communicatively coupled, via an example telematic control unit (TCU) 802 of the vehicle 106 of FIG. 1, to an example cloud-based environment 804 in which the model analysis circuitry 104 may be implemented. In this example, the vehicle analysis circuitry 102 provides, via the TCU 802, the data matrix 324 and associated metadata to the model analysis circuitry 104 in the cloud-based environment 804.

In the illustrated example of FIG. 8, the model analysis circuitry 104 executes, based on data from the data matrix 324, one or more example brake wear prediction model(s) 806 generated based on the neural network 602 of FIG. 6. As a result of the execution, the model analysis circuitry 104 determines and/or predicts example brake wear metric(s) (e.g., mass, width, etc.) associated with brake pads of the vehicle 106. In this example, the model analysis circuitry 104 can provide the predicted brake wear metric(s) to an example dealer (e.g., a manufacturer) 808 of the vehicle 106 for use in determining whether the brake pads are to be inspected and/or changed. Additionally, the model analysis circuitry 104 can provide the predicted brake wear metric(s) to an example customer 810 of the vehicle 106 via, for example, a mobile application, a web page, a portal, etc. In return, the customer 810 can provide example measurement data to the model analysis circuitry 104 for use in training and/or executing the brake wear prediction model(s) 806. For example, the measurement data can include manual measurements (e.g., measured width and/or mass) corresponding to respective ones of the brake pads. In some examples, the model analysis circuitry 104 can provide, via the TCU 802, the predicted and/or measured brake pad metric(s) as example configuration data 812 to the vehicle analysis circuitry 102 for use in updating the data matrix 324 and/or generating one or more additional data matrices.

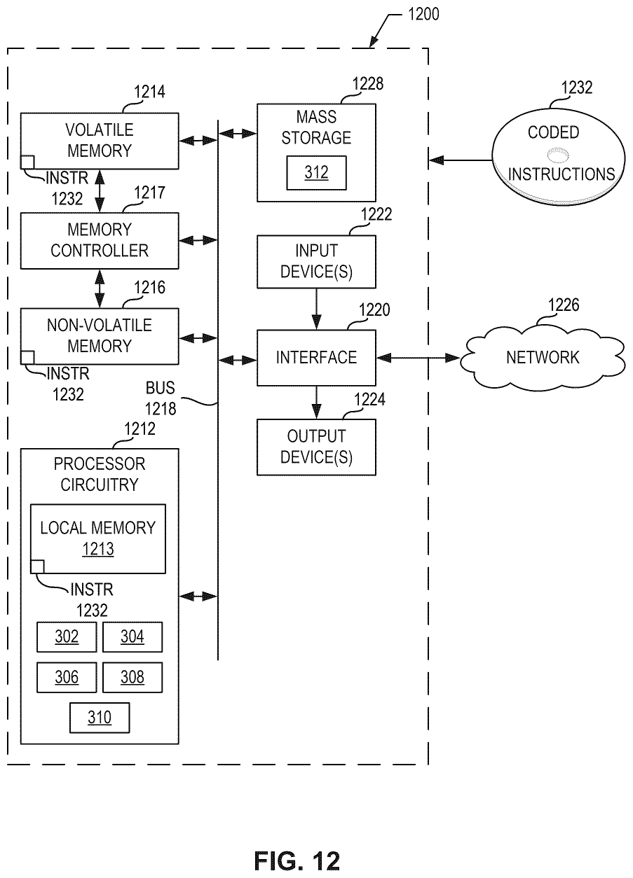

In some examples, the vehicle analysis circuitry 102 includes means for obtaining data, means for calculating power, means for calculating temperature, means for generating a data matrix, and means for transmitting data. For example, the means for obtaining data may be implemented by the data interface circuitry 302, the means for calculating power may be implemented by the power calculation circuitry 304, the means for calculating temperature may be implemented by the temperature calculation circuitry 306, the means for generating a matrix may be implemented by the matrix control circuitry 308, and the means for transmitting data may be implemented by the data transmission circuitry 310. In some examples, the data interface circuitry 302, the power calculation circuitry 304, the temperature calculation circuitry 306, the matrix control circuitry 308, and the data transmission circuitry 310 may be instantiated by programmable circuitry such as the example programmable circuitry 1212 of FIG. 12. Additionally or alternatively, the data interface circuitry 302, the power calculation circuitry 304, the temperature calculation circuitry 306, the matrix control circuitry 308, and the data transmission circuitry 310 may be instantiated by any other combination of hardware, software, and/or firmware. For example, the data interface circuitry 302, the power calculation circuitry 304, the temperature calculation circuitry 306, the matrix control circuitry 308, and the data transmission circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the model analysis circuitry 104 includes means for obtaining input, means for processing, means for training, means for executing, means for outputting, and means for calculating metrics. For example, the means for obtaining input may be implemented by the input interface circuitry 502, the means for processing may be implemented by the data processing circuitry 504, the means for training may be implemented by the model training circuitry 506, the means for executing may be implemented by the model execution circuitry 508, the means for outputting may be implemented by the output circuitry 510, and the means for calculating metrics may be implemented by the metric calculation circuitry 512. In some examples, the input interface circuitry 502, the data processing circuitry 504, the model training circuitry 506, the model execution circuitry 508, the output circuitry 510, and the metric calculation circuitry 512 may be instantiated by programmable circuitry such as the example programmable circuitry 1212 of FIG. 12. Additionally or alternatively, the input interface circuitry 502, the data processing circuitry 504, the model training circuitry 506, the model execution circuitry 508, the output circuitry 510, and the metric calculation circuitry 512 may be instantiated by any other combination of hardware, software, and/or firmware. For example, the input interface circuitry 502, the data processing circuitry 504, the model training circuitry 506, the model execution circuitry 508, the output circuitry 510, and the metric calculation circuitry 512 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the vehicle analysis circuitry 102 of FIG. 1 is illustrated in FIG. 3, one or more of the elements, processes, and/or devices illustrated in FIG. 3 may be combined, divided, re-arranged, omitted, eliminated, and/or implemented in any other way. Further, the example data interface circuitry 302, the example power calculation circuitry 304, the example temperature calculation circuitry 306, the example matrix control circuitry 308, the example data transmission circuitry 310, the example vehicle database 312, and/or, more generally, the example vehicle analysis circuitry 102 of FIG. 3, may be implemented by hardware alone or by hardware in combination with software and/or firmware. Thus, for example, any of the example data interface circuitry 302, the example power calculation circuitry 304, the example temperature calculation circuitry 306, the example matrix control circuitry 308, the example data transmission circuitry 310, the example vehicle database 312, and/or, more generally, the example vehicle analysis circuitry 102, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example vehicle analysis circuitry 102 of FIG. 3 may include one or more elements, processes, and/or devices in addition to, or instead of, those illustrated in FIG. 3, and/or may include more than one of any or all of the illustrated elements, processes and devices.

While an example manner of implementing the model analysis circuitry 104 of FIG. 1 is illustrated in FIG. 5, one or more of the elements, processes, and/or devices illustrated in FIG. 5 may be combined, divided, re-arranged, omitted, eliminated, and/or implemented in any other way. Further, the example input interface circuitry 502, the example data processing circuitry 504, the example model training circuitry 506, the example model execution circuitry 508, the example output circuitry 510, the example metric calculation circuitry 512, the example cloud database 514, and/or, more generally, the example model analysis circuitry 104 of FIG. 5, may be implemented by hardware alone or by hardware in combination with software and/or firmware. Thus, for example, any of the example input interface circuitry 502, the example data processing circuitry 504, the example model training circuitry 506, the example model execution circuitry 508, the example output circuitry 510, the example metric calculation circuitry 512, the example cloud database 514, and/or, more generally, the example model analysis circuitry 104, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example model analysis circuitry 104 of FIG. 5 may include one or more elements, processes, and/or devices in addition to, or instead of, those illustrated in FIG. 5, and/or may include more than one of any or all of the illustrated elements, processes and devices.

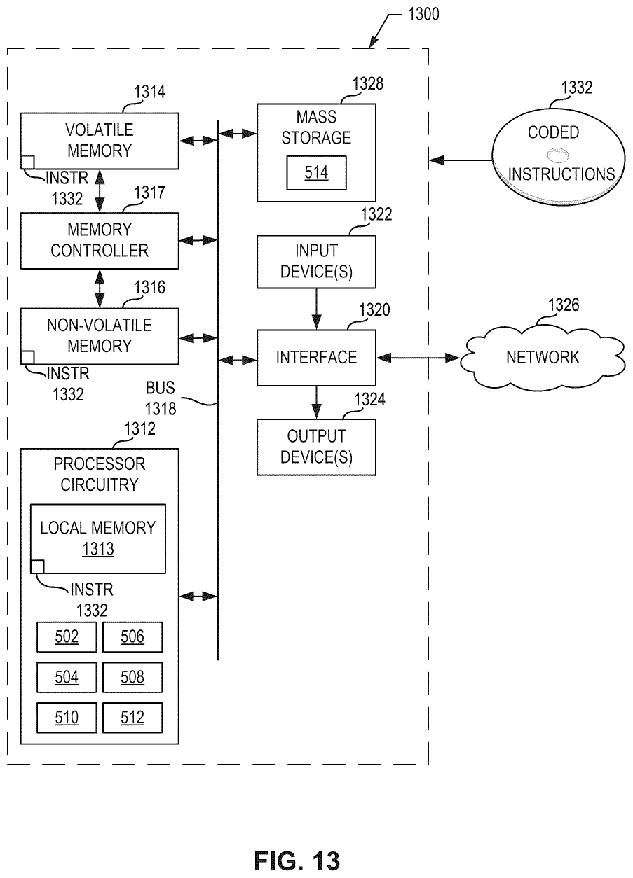

Flowchart(s) representative of example machine readable instructions, which may be executed by programmable circuitry to implement and/or instantiate the vehicle analysis circuitry 102 of FIG. 3 and/or the model analysis circuitry 104 of FIG. 5 and/or representative of example operations which may be performed by programmable circuitry to implement and/or instantiate the vehicle analysis circuitry 102 of FIG. 3 and/or the model analysis circuitry 104 of FIG. 5, are shown in FIGS. 9, 10, and/or 11. The machine readable instructions may be one or more executable programs or portion(s) of one or more executable programs for execution by programmable circuitry such as the programmable circuitry 1212 shown in the example processor platform 1200 discussed below in connection with FIG. 12 and/or the programmable circuitry 1312 shown in the example processor platform 1300 discussed below in connection with FIG. 13. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 9, 10, and/or 11, many other methods of implementing the example vehicle analysis circuitry 102 and/or the model analysis circuitry 104 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 9, 10, and/or 11 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 9 is a flowchart representative of example machine readable instructions and/or example operations 900 that may be executed, instantiated, and/or performed by the vehicle analysis circuitry 102 of FIG. 3 to generate one or more example data matrices (e.g., the data matrix 324 of FIGS. 3 and/or 4). The example machine-readable instructions and/or the example operations 900 of FIG. 9 begin at block 902, at which the example vehicle analysis circuitry 102 initializes the data matrix 324 and the corresponding bins (e.g., the temperature bins 402 and/or the power bins 404). For example, the example matrix control circuitry 308 of FIG. 3 selects a first quantity (e.g., a first bin count) of the temperature bins 402, a second quantity (e.g., a second bin count) of the power bins 404, and/or example ranges (e.g., ranges of values) corresponding to respective ones of the temperature and power bins 402, 404. In some examples, the matrix control circuitry 308 selects the first quantity, the second quantity, and/or the ranges based on user input (e.g., provided via the user interface 118 of FIG. 1) and/or based on selections preloaded in the vehicle analysis circuitry 102. Further, based on the first and second quantities, the matrix control circuitry 308 generates and/or initializes the data matrix 324 having an example row count corresponding to the first quantity and an example column count corresponding to the second quantity. In some examples, the matrix control circuitry 308 selects initial values (e.g., 0) for respective matrix values of the data matrix 324.

At block 904, the example vehicle analysis circuitry 102 accesses example sensor data including the torque data 320, the speed data 322, and the ambient temperature data 318. For example, the data interface circuitry 302 of FIG. 3 accesses the sensor data from one or more of the sensors 112 of the vehicle 106 of FIG. 1.

At block 906, the example vehicle analysis circuitry 102 calculates, based on the torque data 320 and the speed data 322, power applied to the respective wheel(s) 108 of the vehicle 106. For example, the example power calculation circuitry 304 of FIG. 3 calculates example power data based on example Equations 1, 2A, 2B, 2C, and/or 2D above, where the power data includes the power applied by the brake(s) 110 of FIG. 1 onto rotor(s) of the respective wheel(s) 108.

At block 908, the example vehicle analysis circuitry 102 calculates, based on the ambient temperature data 318 and the power applied to the respective wheel(s) 108 (e.g., the power data), temperature(s) at the respective wheel(s) 108. For example, the example temperature calculation circuitry 306 of FIG. 3 calculates example temperature data based on example Equations 3A and/or 3B above, where the temperature data includes the temperature(s) at an interface between brake pad(s) of the brake(s) 110 and the corresponding rotor(s) of the respective wheel(s) 108.

At block 910, the example vehicle analysis circuitry 102 selects bins corresponding to the calculated temperature and power values. For example, the matrix control circuitry 308 selects one(s) of the temperature bins 402 corresponding to the calculated temperature value(s), and further selects one(s) of the power bins 404 corresponding to the calculated power value(s).

At block 912, the example vehicle analysis circuitry 102 updates one or more example matrix values of the data matrix 324 corresponding to the selected bins. For example, the matrix control circuitry 308 selects the matrix value(s) corresponding to the selected ones of the temperature and power bins 402, 404, and updates (e.g., augments, increases (e.g., by 1)) the selected matrix value(s).

At block 914, the example vehicle analysis circuitry 102 determines whether to continue monitoring. For example, the data interface circuitry 302 determines to continue monitoring when the vehicle 106 is travelling and/or operating, and/or when additional sensor data is available from one(s) of the sensors 112 of FIG. 1. In response to the data interface circuitry 302 determining to continue monitoring (e.g., block 914 returns a result of YES), control returns to block 904. Alternatively, in response to the data interface circuitry 302 determining not to continue monitoring (e.g., block 914 returns a result of NO), control proceeds to block 916.

At block 916, the example vehicle analysis circuitry 102 transmits and/or causes storage of the data matrix 324. For example, the example data transmission circuitry 310 of FIG. 3 transmits, via the example network 114 of FIG. 1, the data matrix 324 to the example model analysis circuitry 104 of FIGS. 1 and/or 5 for use in determining one or more example brake wear metrics. Additionally or alternatively, the data transmission circuitry 310 can provide the data matrix 324 to the vehicle database 312 of FIG. 3 for storage therein.

FIG. 10 is a flowchart representative of example machine readable instructions and/or example operations 1000 that may be executed, instantiated, and/or performed by the model analysis circuitry 104 of FIGS. 1 and/or 5 to determine one or more example brake wear metrics. The example machine-readable instructions and/or the example operations 1000 of FIG. 10 begin at block 1002, at which the example model analysis circuitry 104 obtains the example data matrix 324 of FIGS. 3 and/or 4. For example, the example input interface circuitry 502 of FIG. 5 accesses, obtains, and/or retrieves the data matrix 324 generated by the vehicle analysis circuitry 102 for respective wheel(s) 108 of the vehicle 106 of FIG. 1.

At block 1004, the example model analysis circuitry 104 extracts example temperature data and example power data from the data matrix 324. For example, the example data processing circuitry 504 of FIG. 5 extracts and/or obtains the temperature data and the power data from the data matrix 324, where the temperature data includes temperature(s) corresponding to the respective wheel(s) 108 (e.g., at an interface between brake pad(s) of the brake(s) 110 and corresponding rotor(s) of the respective wheel(s) 108), and the power data includes power applied by the brake pad(s) to the corresponding rotor(s) of the respective wheel(s) 108.

At block 1006, the example model analysis circuitry 104 executes one or more example brake wear prediction models (e.g., physics-informed neural network model(s)) based on the temperature data and the power data. For example, the example model execution circuitry 508 of FIG. 5 provides the temperature data and the power data as input to the brake wear prediction model(s), and executes the brake wear prediction model(s) based on the input. Generation and/or training of the brake wear prediction model(s) is described further below in connection with FIG. 11.

At block 1008, the example model analysis circuitry 104 estimates the brake wear metric(s) based on a result of the execution. For example, the model execution circuitry 508 determines and/or estimates, based on a result of the execution, at least one of a mass or a width (e.g., a thickness) corresponding to the brake pad(s) of the respective wheel(s) 108. Additionally or alternatively, the model execution circuitry 508 can determine a change in the mass and/or width of the brake pad(s) (e.g., relative to a starting mass and/or a starting width of the brake pad(s)).

At block 1010, the example model analysis circuitry 104 calculates a remaining useful life (RUL) of the respective brake pad(s) based on the brake wear metric(s). For example, the example metric calculation circuitry 512 calculates and/or estimates the RUL(s) of the brake pad(s) based on example Equation 6 above.

At block 1012, the example model analysis circuitry 104 determines whether one or more metrics (e.g., the brake wear metric(s) and/or the RUL(s)) satisfy associated example criteria. For example, the example output circuitry 510 of FIG. 5 determines the metric(s) are not satisfied when the mass of the brake pad(s) is less than a threshold mass, the width of the brake pad(s) is less than a threshold width, and/or the RUL is less than a threshold RUL. In response to the output circuitry 510 determining that the metric(s) are not satisfied (e.g., block 1012 returns a result of NO), control proceeds to block 1014. Alternatively, in response to the output circuitry 510 determining that the metric(s) are satisfied (e.g., block 1012 returns a result of YES), control proceeds to block 1016.

At block 1014, the example model analysis circuitry 104 generates and/or outputs the example brake wear information 516. For example, the output circuitry 510 generates and/or outputs the brake wear information 516 including the brake wear metric(s) and/or the determined RUL(s) for the respective brake pad(s) of the vehicle 106. In some examples, the output circuitry 510 provides the brake wear information 516 to the vehicle 106 to cause presentation of the brake wear information 516 via the user interface 118 of FIG. 1. In some examples, the output circuitry 510 provides the brake wear information 516 to a manufacturer and/or dealer of the vehicle 106, a service provider of the vehicle 106, an owner of the vehicle 106, etc., to assist in planning of maintenance activities for the vehicle 106.

At block 1016, the example model analysis circuitry 104 determines whether there is at least one additional data matrix to analyze. In response to the input interface circuitry 502 determining that there is at least one additional data matrix to analyze (e.g., block 1016 returns a result of YES), control returns to block 1002. Alternatively, in response to the input interface circuitry 502 determining that there are no additional data matrix to analyze (e.g., block 1016 returns a result of NO), control ends.

FIG. 11 is a flowchart representative of example machine readable instructions and/or example operations 1100 that may be executed, instantiated, and/or performed by the model analysis circuitry 104 of FIGS. 1 and/or 5 to generate and/or train one or more example brake wear prediction models. The example machine-readable instructions and/or the example operations 1100 of FIG. 11 begin at block 1102, at which the example model analysis circuitry 104 obtains the example training data 116 of FIG. 1. For example, the example input interface circuitry 502 obtains the training data 116 including measured and/or simulated mass values (e.g., brake mass values) and corresponding input values (e.g., temperature, power, and/or times) determined and/or obtained based on simulation data, vehicle and/or brake testing data, etc.

At block 1104, the example model analysis circuitry 104 initializes an example neural network (e.g., the neural network 602 of FIG. 6). For example, the example model training circuitry 506 of FIG. 5 generates the neural network 602 having a selected number of layers and/or nodes per layer, and selects initial weights for the neural network 602.

At block 1106, the example model analysis circuitry 104 selects and/or generates one or more example collocation points. For example, the example data processing circuitry 504 selects the collocation points, using a selected sampling method (e.g., Latin hypercube sampling), from an input space defined based on an input temperature range, an input power range, and an input time range.

At block 1108, the example model analysis circuitry 104 executes the neural network 602 based on the training data 116 to determine one or more example predicted mass values (e.g., m) 616. For example, the model training circuitry 506 selects the input values 606 (e.g., the temperature value(s) 608, the corresponding power value(s) 610, and/or the corresponding time value(s) 612) represented in the training data 116, and executes the neural network 602 based on the input values 606. In some examples, as a result of the execution, the model training circuitry 506 determines and/or outputs the predicted mass value(s) 616 corresponding to the input values 606.

At block 1110, the example model analysis circuitry 104 determines one or more predicted mass rates (e.g., predicted mass rate(s) of change) based on evaluation of a partial derivative

$$( e . g . , \frac{\partial \hat{m}}{\partial t} )$$

of the predicted mass value(s) 616 at the collocation points. For example, based on automatic differentiation of the predicted mass value(s) 616, the model training circuitry 506 determines the partial derivative 618 (e.g., a gradient, a rate of change) of the predicted mass value(s) 616, and evaluates the partial derivative 618 at the collocation points to determine the predicted mass rates.

At block 1112, the example model analysis circuitry 104 determines one or more calculated mass rates (e.g., calculated mass rate(s) of change) based on evaluation of a physics-based equation (e.g., the physics-based equation 626 corresponding to example Equation 5 above) at the collocation points. For example, the model training circuitry 506 evaluates example Equation 5 above at the collocation points to determine the calculated mass rates.

At block 1114, the example model analysis circuitry 104 determines a first example loss value (e.g., the first loss value 622) based on a difference between the predicted mass value(s) and the corresponding measured and/or simulated mass value(s). For example, the model training circuitry 506 determines the first loss value 622 based on example Equation 4 above.

At block 1116, the example model analysis circuitry 104 determines a second example loss value (e.g., the second loss value 624) based on a difference between the predicted mass rate(s) and the corresponding calculated mass rate(s). For example, the model training circuitry 506 calculates the difference (e.g., an average difference) between the predicted mass rate(s) and the calculated mass rate(s) for corresponding ones of the collocation points.

At block 1118, the example model analysis circuitry 104 determines a combined loss value 628 based on the first loss value 622 and the second loss value 624. For example, the model training circuitry 506 determines the combined loss value 628 by aggregating (e.g., summing) the first loss value 622 and the second loss value 624.

At block 1120, the example model analysis circuitry 104 determines whether the combined loss value 628 satisfies a threshold (e.g., an error threshold). For example, the model training circuitry 506 determines whether the combined loss value 628 satisfies (e.g., is less than or equal to) the threshold. In response to the model training circuitry 506 determining that the combined loss value 628 satisfies the threshold (e.g., block 1120 returns a result of YES), control proceeds to block 1124. Alternatively, in response to the model training circuitry 506 determining that the combined loss value 628 does not satisfy the threshold (e.g., block 1120 returns a result of NO), control proceeds to block 1122.

At block 1122, the example model analysis circuitry 104 adjusts one or more weights of the neural network 602. For example, the model training circuitry 506 adjusts the weight(s) based on the combined loss value 628. After the model training circuitry 506 adjusts the weight(s), control returns to block 1108 for further training of the neural network 602.

At block 1124, the example model analysis circuitry 104 causes storage of the neural network 602. For example, the model training circuitry 506 generates one or more brake wear prediction model(s) based on the trained network 602, and causes storage of the brake wear prediction model(s) in the cloud database 514 of FIG. 5.

FIG. 12 is a block diagram of an example programmable circuitry platform 1200 structured to execute and/or instantiate the example machine-readable instructions and/or the example operations of FIG. 9 to implement the vehicle analysis circuitry 102 of FIG. 3. The programmable circuitry platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1200 of the illustrated example includes programmable circuitry 1212. The programmable circuitry 1212 of the illustrated example is hardware. For example, the programmable circuitry 1212 can be implemented by one or more integrated circuits, logic circuits, FPGAs, microprocessors, CPUs, GPUs, DSPs, and/or microcontrollers from any desired family or manufacturer. The programmable circuitry 1212 may be implemented by one or more semiconductor based (e.g., silicon based) devices. In this example, the programmable circuitry 1212 implements the data interface circuitry 302, the power calculation circuitry 304, the temperature calculation circuitry 306, the matrix control circuitry 308, the data transmission circuitry 310, and the vehicle database 312.

The programmable circuitry 1212 of the illustrated example includes a local memory 1213 (e.g., a cache, registers, etc.). The programmable circuitry 1212 of the illustrated example is in communication with main memory 1214, 1216, which includes a volatile memory 1214 and a non-volatile memory 1216, by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. Access to the main memory 1214, 1216 of the illustrated example is controlled by a memory controller 1217. In some examples, the memory controller 1217 may be implemented by one or more integrated circuits, logic circuits, microcontrollers from any desired family or manufacturer, or any other type of circuitry to manage the flow of data going to and from the main memory 1214, 1216.

The programmable circuitry platform 1200 of the illustrated example also includes interface circuitry 1220. The interface circuitry 1220 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1222 are connected to the interface circuitry 1220. The input device(s) 1222 permit(s) a user (e.g., a human user, a machine user, etc.) to enter data and/or commands into the programmable circuitry 1212. The input device(s) 1222 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1224 are also connected to the interface circuitry 1220 of the illustrated example. The output device(s) 1224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1220 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1200 of the illustrated example also includes one or more mass storage discs or devices 1228 to store firmware, software, and/or data. Examples of such mass storage discs or devices 1228 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1232, which may be implemented by the machine readable instructions of FIG. 9, may be stored in the mass storage device 1228, in the volatile memory 1214, in the non-volatile memory 1216, and/or on at least one non-transitory computer readable storage medium such as a CD or DVD which may be removable.

FIG. 13 is a block diagram of an example programmable circuitry platform 1300 structured to execute and/or instantiate the example machine-readable instructions and/or the example operations of FIGS. 10 and/or 11 to implement the model analysis circuitry 104 of FIG. 5. The programmable circuitry platform 1300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1300 of the illustrated example includes programmable circuitry 1312. The programmable circuitry 1312 of the illustrated example is hardware. For example, the programmable circuitry 1312 can be implemented by one or more integrated circuits, logic circuits, FPGAs, microprocessors, CPUs, GPUs, DSPs, and/or microcontrollers from any desired family or manufacturer. The programmable circuitry 1312 may be implemented by one or more semiconductor based (e.g., silicon based) devices. In this example, the programmable circuitry 1312 implements the input interface circuitry 502, the data processing circuitry 504, the model training circuitry 506, the model execution circuitry 508, the output circuitry 510, the metric calculation circuitry 512, and the cloud database 514.

The programmable circuitry 1312 of the illustrated example includes a local memory 1313 (e.g., a cache, registers, etc.). The programmable circuitry 1312 of the illustrated example is in communication with main memory 1314, 1316, which includes a volatile memory 1314 and a non-volatile memory 1316, by a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1316 may be implemented by flash memory and/or any other desired type of memory device. Access to the main memory 1314, 1316 of the illustrated example is controlled by a memory controller 1317. In some examples, the memory controller 1317 may be implemented by one or more integrated circuits, logic circuits, microcontrollers from any desired family or manufacturer, or any other type of circuitry to manage the flow of data going to and from the main memory 1314, 1316.

The programmable circuitry platform 1300 of the illustrated example also includes interface circuitry 1320. The interface circuitry 1320 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1322 are connected to the interface circuitry 1320. The input device(s) 1322 permit(s) a user (e.g., a human user, a machine user, etc.) to enter data and/or commands into the programmable circuitry 1312. The input device(s) 1322 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1324 are also connected to the interface circuitry 1320 of the illustrated example. The output device(s) 1324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1320 of the illustrated example, thus, typically includes a graphics driver card, a graphics driver chip, and/or graphics processor circuitry such as a GPU.

The interface circuitry 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1300 of the illustrated example also includes one or more mass storage discs or devices 1328 to store firmware, software, and/or data. Examples of such mass storage discs or devices 1328 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1332, which may be implemented by the machine readable instructions of FIGS. 10 and/or 11, may be stored in the mass storage device 1328, in the volatile memory 1314, in the non-volatile memory 1316, and/or on at least one non-transitory computer readable storage medium such as a CD or DVD which may be removable.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that estimate brake pad wear for a vehicle. Examples disclosed herein obtain sensor data (e.g., ambient temperature data, torque data, and/or speed data) from one or more vehicle sensors of the vehicle, and calculate, based on the sensor data, example temperature data and example power data corresponding to respective brakes and/or brake pads of the vehicle. Disclosed examples generate an example data matrix (e.g., a histogram matrix) based on the temperature data and the power data, then stores and/or transmits the data matrix to an example cloud-based environment. In some examples, by storing and/or transmitting data using the data matrix, disclosed examples reduce utilization of computational resources (e.g., memory, bandwidth, etc.) for storage and/or transmission. Further, disclosed examples generate and/or train, in the cloud-based environment, one or more example brake wear prediction models for use in estimating wear of the brake pads based on the data matrix. For example, the brake wear prediction models are physics-informed neural network (PINN) models that are trained based on labelled training data and based on known and/or expected dynamics of material wear (e.g., represented using one or more physics-based equations). In some examples, by training the model(s) based on the known and/or expected dynamics, disclosed examples can improve accuracy of predictions output by the model(s) when the inputs to the model(s) are outside of a range represented in the training data. As a result, disclosed examples can reduce a quantity of training data necessary to generate and/or train the model(s), thus reducing utilization of computation resources (e.g., memory, bandwidth) for storage and/or transmission of the training data. Accordingly, disclosed systems, apparatus, articles of manufacture, and methods improve the efficiency of using a computing device.

Additionally, examples disclosed herein can execute the model(s) to predict and/or estimate brake wear metric(s) (e.g., mass and/or width) of the brake pads. The brake wear metric(s) can be used to inform and/or plan maintenance activities (e.g., replacement) of the brake pads. As a result, disclosed examples can reduce premature replacement of the brake pads, and/or can reduce deterioration of one or more rotors of the vehicle resulting from late and/or delayed replacement of the brake pads. Disclosed systems, apparatus, articles of manufacture, and methods are accordingly directed to one or more improvement(s) in the operation of a machine or other electronic and/or mechanical device.

Example methods, apparatus, systems, and articles of manufacture to estimate brake pad wear are disclosed herein. Further examples and combinations thereof include the following:
Example 1 includes an apparatus comprising interface circuitry, machine-readable instructions, and at least one processor circuit to be programmed by the machine-readable instructions to obtain temperature data and power data associated with a brake pad of a vehicle, execute a neural network based on the temperature data and the power data, the neural network trained based on a loss value corresponding to a difference between (a) a first rate of change of an output of the neural network when the neural network is executed based on training data, the first rate of change evaluated at a first temperature and a first power, and (b) a second rate of change proportional to a ratio between the first temperature and the first power, determine, based on a result of the execution of the neural network, a brake wear metric corresponding to the brake pad, and cause presentation of the brake pad metric via a user interface.
Example 2 includes the apparatus of example 1, wherein the brake wear metric includes at least one of a width of the brake pad, a mass of the brake pad, or a change in at least one of the width or the mass.
Example 3 includes the apparatus of example 1, wherein one or more of the at least one processor circuit is to determine a remaining useful life of the brake pad based on the brake wear metric.
Example 4 includes the apparatus of example 1, wherein the loss value is a first loss value, the difference is a first difference, and wherein one or more of the at least one processor circuit is to determine a second loss value based on a second difference between the output of the neural network and a measured value, the measured value included in the training data, and adjust weights of the neural network based on a combination of the first loss value and the second loss value.
Example 5 includes the apparatus of example 1, wherein the second rate of change is based on a material of the brake pad and a vehicle speed.
Example 6 includes the apparatus of example 1, wherein one or more of the at least one processor circuit is to obtain the temperature data and the power data based on a matrix generated at the vehicle, a matrix value of the matrix corresponding to a first bin value and a second bin value, the first bin value corresponding to the temperature data and the second bin value corresponding to the power data.
Example 7 includes the apparatus of example 1, wherein one or more of the at least one processor circuit is to cause the presentation of the brake wear metric when the brake wear metric does not satisfy a threshold.
Example 8 includes at least one non-transitory machine-readable medium comprising machine-readable instructions to cause at least one processor circuit to at least obtain temperature data and power data associated with a brake pad of a vehicle, execute a neural network based on the temperature data and the power data, the neural network trained based on a loss value corresponding to a difference between (a) a first rate of change of an output of the neural network when the neural network is executed based on training data, the first rate of change evaluated at a first temperature and a first power, and (b) a second rate of change proportional to a ratio between the first temperature and the first power, determine, based on a result of the execution of the neural network, a brake wear metric corresponding to the brake pad, and cause presentation of the brake pad metric via a user interface.
Example 9 includes the at least one non-transitory machine-readable medium of example 8, wherein the brake wear metric includes at least one of a width of the brake pad, a mass of the brake pad, or a change in at least one of the width or the mass.
Example 10 includes the at least one non-transitory machine-readable medium of example 8, wherein the machine-readable instructions are to cause one or more of the at least one processor circuit to determine a remaining useful life of the brake pad based on the brake wear metric.
Example 11 includes the at least one non-transitory machine-readable medium of example 8, wherein the loss value is a first loss value, the difference is a first difference, and wherein the machine-readable instructions are to cause one or more of the at least one processor circuit to determine a second loss value based on a second difference between the output of the neural network and a measured value, the measured value included in the training data, and adjust weights of the neural network based on a combination of the first loss value and the second loss value.
Example 12 includes the at least one non-transitory machine-readable medium of example 8, wherein the second rate of change is based on a material of the brake pad and a vehicle speed.
Example 13 includes the at least one non-transitory machine-readable medium of example 8, wherein the machine-readable instructions are to cause one or more of the at least one processor circuit to obtain the temperature data and the power data based on a matrix generated at the vehicle, a matrix value of the matrix corresponding to a first bin value and a second bin value, the first bin value corresponding to the temperature data and the second bin value corresponding to the power data.
Example 14 includes the at least one non-transitory machine-readable medium of example 8, wherein the machine-readable instructions are to cause one or more of the at least one processor circuit to cause the presentation of the brake wear metric when the brake wear metric does not satisfy a threshold.
Example 15 includes a method comprising obtaining temperature data and power data associated with a brake pad of a vehicle, executing a neural network based on the temperature data and the power data, the neural network trained based on a loss value corresponding to a difference between (a) a first rate of change of an output of the neural network when the neural network is executed based on training data, the first rate of change evaluated at a first temperature and a first power, and (b) a second rate of change proportional to a ratio between the first temperature and the first power, determining, based on a result of the execution of the neural network, a brake wear metric corresponding to the brake pad, and causing presentation of the brake pad metric via a user interface.
Example 16 includes the method of example 15, wherein determining the brake wear metric includes determining at least one of a width of the brake pad, a mass of the brake pad, or a change in at least one of the width or the mass.
Example 17 includes the method of example 15, further including determining a remaining useful life of the brake pad based on the brake wear metric.
Example 18 includes the method of example 15, wherein the loss value is a first loss value, the difference is a first difference, and further including determining a second loss value based on a second difference between the output of the neural network and a measured value, the measured value included in the training data, and adjusting weights of the neural network based on a combination of the first loss value and the second loss value.
Example 19 includes the method of example 15, wherein the second rate of change is based on a material of the brake pad and a vehicle speed.
Example 20 includes the method of example 15, further including obtaining the temperature data and the power data based on a matrix generated at the vehicle, a matrix value of the matrix corresponding to a first bin value and a second bin value, the first bin value corresponding to the temperature data and the second bin value corresponding to the power data.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine-readable instructions; and
at least one processor circuit to be programmed by the machine-readable instructions to:
obtain temperature data and power data associated with a brake pad of a vehicle;
execute a neural network based on the temperature data and the power data, the neural network trained based on a loss value corresponding to a difference between (a) a first rate of change of an output of the neural network when the neural network is executed based on training data, the first rate of change evaluated at a first temperature and a first power, and (b) a second rate of change proportional to a ratio between the first temperature and the first power;
determine, based on a result of the execution of the neural network, a brake wear metric corresponding to the brake pad; and
cause presentation of the brake pad metric via a user interface.

2. The apparatus of claim 1, wherein the brake wear metric includes at least one of a width of the brake pad, a mass of the brake pad, or a change in at least one of the width or the mass.

3. The apparatus of claim 1, wherein one or more of the at least one processor circuit is to determine a remaining useful life of the brake pad based on the brake wear metric.

4. The apparatus of claim 1, wherein the loss value is a first loss value, the difference is a first difference, and wherein one or more of the at least one processor circuit is to:
determine a second loss value based on a second difference between the output of the neural network and a measured value, the measured value included in the training data; and
adjust weights of the neural network based on a combination of the first loss value and the second loss value.

5. The apparatus of claim 1, wherein the second rate of change is based on a material of the brake pad and a vehicle speed.

6. The apparatus of claim 1, wherein one or more of the at least one processor circuit is to obtain the temperature data and the power data based on a matrix generated at the vehicle, a matrix value of the matrix corresponding to a first bin value and a second bin value, the first bin value corresponding to the temperature data and the second bin value corresponding to the power data.

7. The apparatus of claim 1, wherein one or more of the at least one processor circuit is to cause the presentation of the brake wear metric when the brake wear metric does not satisfy a threshold.

8. At least one non-transitory machine-readable medium comprising machine-readable instructions to cause at least one processor circuit to at least:
obtain temperature data and power data associated with a brake pad of a vehicle;
execute a neural network based on the temperature data and the power data, the neural network trained based on a loss value corresponding to a difference between (a) a first rate of change of an output of the neural network when the neural network is executed based on training data, the first rate of change evaluated at a first temperature and a first power, and (b) a second rate of change proportional to a ratio between the first temperature and the first power;
determine, based on a result of the execution of the neural network, a brake wear metric corresponding to the brake pad; and
cause presentation of the brake pad metric via a user interface.

9. The at least one non-transitory machine-readable medium of claim 8, wherein the brake wear metric includes at least one of a width of the brake pad, a mass of the brake pad, or a change in at least one of the width or the mass.

10. The at least one non-transitory machine-readable medium of claim 8, wherein the machine-readable instructions are to cause one or more of the at least one processor circuit to determine a remaining useful life of the brake pad based on the brake wear metric.

11. The at least one non-transitory machine-readable medium of claim 8, wherein the loss value is a first loss value, the difference is a first difference, and wherein the machine-readable instructions are to cause one or more of the at least one processor circuit to:
determine a second loss value based on a second difference between the output of the neural network and a measured value, the measured value included in the training data; and
adjust weights of the neural network based on a combination of the first loss value and the second loss value.

12. The at least one non-transitory machine-readable medium of claim 8, wherein the second rate of change is based on a material of the brake pad and a vehicle speed.

13. The at least one non-transitory machine-readable medium of claim 8, wherein the machine-readable instructions are to cause one or more of the at least one processor circuit to obtain the temperature data and the power data based on a matrix generated at the vehicle, a matrix value of the matrix corresponding to a first bin value and a second bin value, the first bin value corresponding to the temperature data and the second bin value corresponding to the power data.

14. The at least one non-transitory machine-readable medium of claim 8, wherein the machine-readable instructions are to cause one or more of the at least one processor circuit to cause the presentation of the brake wear metric when the brake wear metric does not satisfy a threshold.

15. A method comprising:
obtaining temperature data and power data associated with a brake pad of a vehicle;
executing a neural network based on the temperature data and the power data, the neural network trained based on a loss value corresponding to a difference between (a) a first rate of change of an output of the neural network when the neural network is executed based on training data, the first rate of change evaluated at a first temperature and a first power, and (b) a second rate of change proportional to a ratio between the first temperature and the first power;
determining, based on a result of the execution of the neural network, a brake wear metric corresponding to the brake pad; and
causing presentation of the brake pad metric via a user interface.

16. The method of claim 15, wherein determining the brake wear metric includes determining at least one of a width of the brake pad, a mass of the brake pad, or a change in at least one of the width or the mass.

17. The method of claim 15, further including determining a remaining useful life of the brake pad based on the brake wear metric.

18. The method of claim 15, wherein the loss value is a first loss value, the difference is a first difference, and further including:
determining a second loss value based on a second difference between the output of the neural network and a measured value, the measured value included in the training data; and
adjusting weights of the neural network based on a combination of the first loss value and the second loss value.

19. The method of claim 15, wherein the second rate of change is based on a material of the brake pad and a vehicle speed.

20. The method of claim 15, further including obtaining the temperature data and the power data based on a matrix generated at the vehicle, a matrix value of the matrix corresponding to a first bin value and a second bin value, the first bin value corresponding to the temperature data and the second bin value corresponding to the power data.
